(19) United States
(12) Patent Application Publication
(10) Pub. No.: US 2024/0107632 A1
(43) Pub. Date: Mar. 28, 2024

(54) VARIABLE HEATING DEVICE

(71) Applicant: GRAPHENE SQUARE INC., Suwon-si (KR)

(72) Inventors: Seong Chae PARK, Seongnam-si (KR); Quangtrung TRUONG, Gunpo-si (KR)

(21) Appl. No.: 18/276,523

(22) PCT Filed: Feb. 10, 2022
(86) PCT No.: PCT/KR2022/002014

§ 371 Date: Aug. 9, 2023

(30) Foreign Application Priority Data
Feb. 10, 2021 (KR) 10-2021-0019317

(51) Int. Cl. H05B 3/02; H05B 3/68; H05B 3/74

(52) U.S. Cl. CPC H05B 3/02; H05B 3/68; H05B 3/74

(57) ABSTRACT

The present disclosure can provide a variable heating apparatus which allows a user to easily observe the process of cooking food because a heating region is transparent, and which can perform multi-functions because of its deformability.

### CROSS REFERENCE TO RELATED APPLICATIONS

This application claims the benefit of Korean Patent Application No. 10-2021-0019317, filed with the Korean Intellectual Property Office on Feb. 10, 2021, the contents of which are incorporated herein by reference in its entirety.

### TECHNICAL FIELD

The present disclosure relates to a variable heating apparatus, and more particularly, to a heating apparatus whose heating region is formed transparently and is deformable.

### BACKGROUND ART

Recently, as the number of one-person households increases, the demand for multi-function or compact kitchen appliances is increasing. Particularly, in relation to heating cooking utensils, there is growing interest in cooking utensils capable of cooking food using electricity because using a gas stove causes problems such as toxic gas generated by gas ignition or the like, gas leakage, and the like.

In general, cooking utensils for heating food using electricity are opaque, making it difficult to observe the cooking process of food and difficult to be kept sanitarily.

Accordingly, there is a need to develop a heating cooking utensil which can allow a user to easily observe the process of cooking food, can be hygienically managed, and can perform multi-functions.

### DISCLOSURE

### Technical Problem

An objective achieved by the present disclosure is to provide a variable heating apparatus which is capable of performing multi-functions because of its deformability, and capable of allowing the user to easily observe a heating process of an object because a heating region is transparent.

However, the objectives to be achieved by the present disclosure are not limited to the above-mentioned one, and other unmentioned objectives will be clearly understood by those skilled in the art from the following description.

### Technical Solution

An embodiment of the present disclosure provides a variable heating apparatus including a first transparent heating part including a first transparent heat generating body; a second transparent heating part including a second transparent heat generating body; and a folding part provided between the first transparent heating part and the second transparent heating part.

### Advantageous Effects

The variable heating apparatus according to an embodiment of the present disclosure has a region for heating an object, which is transparent, so that a process of heating the object by the variable heating apparatus can be easily observed.

The variable heating apparatus according to an embodiment of the present disclosure has a region for heating an object, which is transparent, so that the variable heating apparatus can be managed hygienically with ease.

The variable heating apparatus according to an embodiment of the present disclosure can be deformed via a folding part, so there is an advantage in that it can heat various objects easily.

The effects of the present disclosure are not limited to the aforementioned ones, but other unmentioned effects thereof will be clearly understood by those skilled in the art from the present specification and the accompanying drawings.

### BRIEF DESCRIPTION OF DRAWINGS

FIG. 1A shows a schematic view in which a variable heating apparatus according to an embodiment of the present disclosure is in its folded state, and FIG. 1B shows a schematic view in which the variable heating apparatus is in its unfolded state.

FIG. 2A shows a schematic top view of a variable heating apparatus according to an embodiment of the present disclosure, FIG. 2B shows a schematic cross-sectional view of the variable heating apparatus taken along line A-B in FIG. 2A, and FIG. 2C shows a schematic cross-sectional view of the variable heating apparatus taken along line C-D in FIG. 2A.

FIG. 3A shows a schematic top view of a variable heating apparatus according to an embodiment of the present disclosure, and FIG. 3B shows a schematic cross-sectional view of the variable heating apparatus taken along line A-B in FIG. 3A.

FIG. 4A shows a schematic view representing a variable heating apparatus according to an embodiment of the present disclosure with its folding part detached therefrom, and FIG. 4B shows a variable heating apparatus according to an embodiment of the present disclosure in which the distance between the first transparent heating part and the second transparent heating part can be adjusted by deforming the folding part.

FIG. 5A shows a schematic top view of a variable heating apparatus according to an embodiment of the present disclosure, and FIG. 5B shows a schematic cross-sectional view of the variable heating apparatus taken along line A-B in FIG. 5A.

FIG. 6A shows a schematic plan view of a variable heating apparatus provided with a control part, a temperature display part, a driving time control part, and a light emitting device according to an embodiment of the present disclosure, and FIG. 6B shows a schematic plan view of a variable heating apparatus provided with a control part, a temperature display part, a driving time control part, and an image display part according to an embodiment of the present disclosure.

FIGS. 7A to 7D show diagrams illustrating electrodes included in a variable heating apparatus according to an embodiment of the present disclosure.

FIG. 8A shows a schematic view in which a variable heating apparatus according to an embodiment of the present disclosure is in its folded state, and FIG. 8B shows a schematic view in which the variable heating apparatus is in its unfolded state.

FIG. 9A shows a schematic top view of a variable heating apparatus according to an embodiment of the present disclosure, and FIG. 9B shows a schematic cross-sectional view of the variable heating apparatus taken along line A-B in FIG. 9A.

FIG. 10A shows a schematic top view of a variable heating apparatus according to an embodiment of the present disclosure, FIG. 10B shows a schematic cross-sectional view of the variable heating apparatus taken along line A-B in FIG. 10A, and FIG. 10C shows a schematic cross-sectional view of the variable heating apparatus taken along line C-D in FIG. 10A.

FIG. 11 shows a schematic cross-sectional view of a variable heating apparatus provided with a transparent auxiliary layer according to an embodiment of the present disclosure.

FIGS. 12A and 12B schematically illustrate states in which a folding part of a variable heating apparatus according to an embodiment of the present disclosure is attached and detached.

FIGS. 13A and 13B show a variable heating apparatus according to an embodiment of the present disclosure in which the distance between the first transparent heating part and the second transparent heating part can be adjusted by deforming the folding part.

FIG. 14A shows a schematic top view of a variable heating apparatus according to an embodiment of the present disclosure, and FIG. 14B shows a schematic cross-sectional view of the variable heating apparatus taken along line A-B in FIG. 14A.

FIGS. 15A and 15B show schematic cross-sectional views of variable heating apparatuses provided with transparent protective layers according to an embodiment of the present disclosure.

FIG. 16 shows a cross-sectional view of a variable heating apparatus according to an embodiment of the present disclosure.

FIG. 17 shows a photographic image of a silver (Ag) electrode formed in a grid pattern as an auxiliary electrode on glass, which is a transparent substrate, according to an embodiment of the present disclosure.

### BEST MODE FOR PRACTICING DISCLOSURE

An embodiment of the present disclosure provides a variable heating apparatus including a first transparent heating part including a first transparent heat generating body; a second transparent heating part including a second transparent heat generating body; and a folding part provided between the first transparent heating part and the second transparent heating part.

According to an embodiment of the present disclosure, the first transparent heat generating body and the second transparent heat generating body may be graphene thin films.

According to an embodiment of the present disclosure, the graphene thin film may include a single graphene layer or a plurality of graphene layers.

According to an embodiment of the present disclosure, the graphene thin film may be doped with a dopant.

According to an embodiment of the present disclosure, the first transparent heating part may include a first transparent substrate provided with the first transparent heat generating body, and a second transparent substrate facing the first transparent substrate with the first transparent heat generating body interposed therebetween, the second transparent heating part may include a third transparent substrate provided with the second transparent heat generating body, and a fourth transparent substrate facing the third transparent substrate with the second transparent heat generating body interposed therebetween, the first transparent substrate and the second transparent substrate may be sealed such that an air gap is formed between the first transparent substrate and the second transparent substrate, and the third transparent substrate and the fourth transparent substrate may be sealed such that an air gap is formed between the third transparent substrate and the fourth transparent substrate.

According to an embodiment of the present disclosure, the first transparent heating part may include a first spacer which is provided between the first transparent substrate and the second transparent substrate to seal the first transparent substrate and the second transparent substrate, and the second transparent heating part may include a second spacer which is provided between the third transparent substrate and the fourth transparent substrate to seal the third transparent substrate and the fourth transparent substrate.

According to an embodiment of the present disclosure, the air gap may contain an inert gas.

According to an embodiment of the present disclosure, the first transparent heating part may further include an electrode connected to the first transparent heat generating body, and the second transparent heating part may further include an electrode connected to the second transparent heat generating body.

According to an embodiment of the present disclosure, the folding part may be attachable to and detachable from the first transparent heating part and the second transparent heating part.

According to an embodiment of the present disclosure, the variable heating apparatus may further include a transparent flexible substrate, the transparent flexible substrate may include a first transparent heating zone provided with the first transparent heating part; a second transparent heating zone provided with the second transparent heating part; and a folding zone located between the first transparent heating part and the second transparent heating part, and the folding part may be a portion of the transparent flexible substrate corresponding to the folding zone.

According to an embodiment of the present disclosure, the variable heating apparatus may further include a first temperature control part connected to the first transparent heat generating body to control the degree of heat generation of the first transparent heat generating body; and a second temperature control part connected to the second transparent heat generating body to control the degree of heat generation of the second transparent heat generating body.

According to an embodiment of the present disclosure, the variable heating apparatus may further include a first driving time control part connected to the first transparent heat generating body to control the driving time of the first transparent heat generating body; and a second driving time control part connected to the second transparent heat generating body to control the driving time of the second transparent heat generating body.

According to an embodiment of the present disclosure, the variable heating apparatus may further include a first display part connected to the first transparent heat generating body to display driving information including temperature and driving time of the first transparent heat generating body; and a second display part connected to the second transparent heat generating body to display driving information including temperature and driving time of the second transparent heat generating body.

According to an embodiment of the present disclosure, each of the first display part and the second display part may include a light emitting device that changes its color according to the temperature of the transparent heat generating body.

According to an embodiment of the present disclosure, at least one of the first transparent heating part and the second transparent heating part may further include an image display part for outputting an image.

According to an embodiment of the present disclosure, the first transparent heating part may further include a first transparent substrate provided with the first transparent heat generating body, and an electrode connected to the first transparent heat generating body, and the second transparent heating part may further include a second transparent substrate provided with the second transparent heat generating body, and an electrode connected to the second transparent heat generating body.

According to an embodiment of the present disclosure, the first transparent heating part further includes a first transparent auxiliary layer provided between the first transparent heat generating body and the first transparent substrate, and the second transparent heating part may further include a second transparent auxiliary layer provided between the second transparent heat generating body and the second transparent substrate.

According to an embodiment of the present disclosure, the first transparent heating part further includes a first transparent protective layer provided on the first transparent heat generating body, and the second transparent heating part may further include a second transparent protective layer provided on the second transparent heat generating body.

### Mode for Disclosure

Throughout the specification of the present application, when a part “includes” or “comprises” a component, it does not mean that the part excludes other component, but instead that the part may further include other component unless expressly stated to the contrary.

In the specification, when a member is described as being located “on” another member, this includes not only a case in which the member is in contact with the other member but also a case in which another member exists between the two members.

In the specification, the phrase “a step to” or “a step of” does not mean “a step for”.

In the present specification, the phrase “graphene layer” refers to a film or sheet form of graphene in which a plurality of carbon atoms are linked to each other by covalent bonds to form a polycyclic aromatic molecule, and the carbon atoms linked by covalent bonds form a 6-membered ring as a basic repeating unit, but it is also possible to further include a 5-membered ring and/or a 7-membered ring. The “graphene layer” thus appears as a single layer of carbon atoms covalently bonded to each other (typically sp² bonds). The “graphene layer” may have various structures, and such structures may vary depending on the content(s) of 5-membered rings and/or 7-membered rings that may be included in the graphene. The “graphene layer” may be formed of a single layer of graphene as described above, but it is also possible to form a plurality of layers by stacking several graphene layers, and may form a thickness of up to 100 nm.

In the present specification, the “transparent heating part” may collectively refer to the first transparent heating part and the second transparent heating part; the “transparent heat generating body” may collectively refer to the first transparent heat generating body and the second transparent heat generating body; the “transparent substrate” may collectively refer to the first transparent substrate and the second transparent substrate; the “transparent auxiliary layer” may collectively refer to the first transparent auxiliary layer and the second transparent auxiliary layer; and the “transparent protective layer” may collectively refer to the first transparent protective layer and the second transparent protective layer.

Hereinafter, specific contents on practicing the present disclosure will be described in detail with reference to the accompanying drawings.

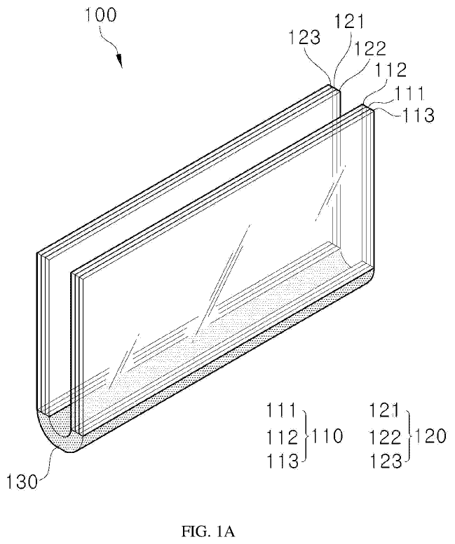

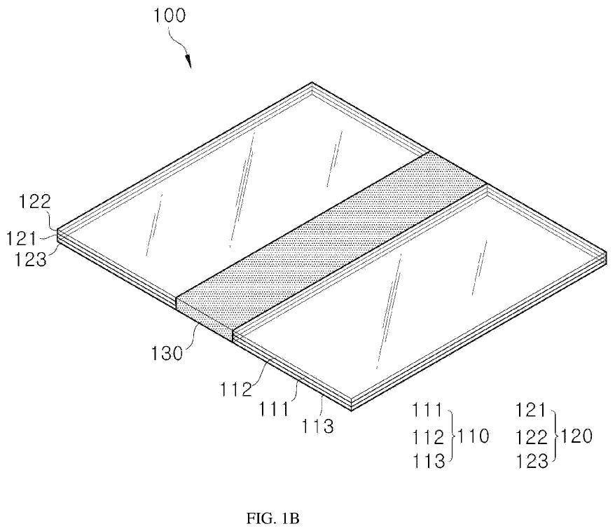

FIG. 1A shows a schematic view in which a variable heating apparatus according to an embodiment of the present disclosure is in its folded state, and FIG. 1B shows a schematic view in which the variable heating apparatus is in its unfolded state. FIGS. 1A and 1B schematically show the configuration of the variable heating apparatus with some components such as a spacer, an electrode and the like to be described later omitted for convenience of explanation.

An embodiment of the present disclosure provides a variable heating apparatus including a first transparent heating part including a first transparent heat generating body; a second transparent heating part including a second transparent heat generating body; and a folding part provided between the first transparent heating part and the second transparent heating part.

The variable heating apparatus according to an embodiment of the present disclosure has a region for heating an object, which is transparent, so that a process of heating the object by the variable heating apparatus can be easily observed and the variable heating apparatus can be managed hygienically with ease. In addition, the variable heating apparatus can be deformed via the folding part, so there is an advantage in that it can heat various objects easily.

Referring to FIGS. 1A and 1B, the variable heating apparatus 100 includes a first transparent heating part 110, a second transparent heating part 120, and a folding part 130. In this case, the folding part 130 may be provided between the first transparent heating part 110 and the second transparent heating part 120. As shown in FIG. 1A, the variable heating apparatus 100 may be folded via the folding part 130 so that the first transparent heating part 110 and the second transparent heating part 120 face each other. As shown in FIG. 1B, the variable heating apparatus 100 may be unfolded via the folding part 130 so that both the first transparent heating part 110 and the second transparent heating part 120 are horizontal to the place (e.g., the ground) where the variable heating apparatus 100 is disposed. That is, the variable heating apparatus 100 may be a kind of a foldable heating apparatus.

Referring to FIGS. 1A and 1B, the first transparent heat generating body 111 of the first transparent heating part 110 and the second transparent heat generating body 121 of the second transparent heating part 120 can form an angle of 0° or more and 180° or less with each other via the folding part 130.

According to an embodiment of the present disclosure, the variable heating apparatus can be deformed via the folding part, so that it can heat various kinds of objects. For example, the variable heating apparatus may be a kind of a heating apparatus for cooking food. Specifically, in its folded state, the variable heating apparatus may serve as a toaster or the like to bake a slice of bread, meat or the like. That is, the variable heating apparatus may be a kind of variable transparent toaster. Additionally, in its folded or unfolded state, the variable heating apparatus can cook meat such as pork, beef, and the like, fish such as mackerel, Spanish mackerel, and the like, vegetables and wild vegetables such as spinach, Chinese cabbage, Pak Choi, and the like, processed foods such as pizza, dumplings, and the like. However, it will be understood by those of ordinary skill in the art that the types of objects which can be cooked using the variable heating apparatus are not limited to those described above.

Also, in its unfolded state, the variable heating apparatus may serve as a hot tray to cook food or keep cooked food warm. Therefore, the variable heating apparatus can implement multiple functions through the folding. In addition, the variable heating apparatus can be stored or kept in its folded state, so that it can be easily stored and transported.

According to an embodiment of the present disclosure, the variable heating apparatus may heat the object to a temperature of 800° C. or less. Specifically, the temperature to which the variable heating apparatus heats the object may be 700° C. or less, 600° C. or less, 500° C. or less, 400° C. or less, 300° C. or less, 200° C. or less, 100° C. or less, or 50° C. or less. In addition, the temperature to which the variable heating apparatus heats the object may be 35° C. or more, 50° C. or more, 75° C. or more, 100° C. or more, 200° C. or more, 300° C. or more, 400° C. or more, 500° C. or more, 600° C. or more, or 700° C. or more. The aforementioned temperature to which the object is heated may be a temperature to which the first and second transparent heating parts are heated. As will be described later, the temperature to which the first transparent heating part (first transparent heat generating body) is heated can be controlled through a first temperature control part, and the temperature to which the second transparent heating part (second transparent heat generating body) is heated can be controlled through a second temperature control part.

According to an embodiment of the present disclosure, the first transparent heating part and the second transparent heating part may be transparent. That is, there is an advantage in that it is possible to observe in real time the heating degree, state or the like of an object which is being heated by coming into contact with the first and second transparent heating parts. In addition, since the first and second transparent heating parts are transparent, it is easy to check the presence of foreign substances attached to the first or second transparent heating parts, and thus, there is an advantage in that they can be hygienically managed.

According to an embodiment of the present disclosure, the first transparent heat generating body and the second transparent heat generating body may be graphene thin films. Although materials other than graphene may be used as the first and second transparent heat generating bodies, the following will focus on an embodiment in which graphene is used as the first and second transparent heat generating bodies, seeing that graphene has the excellent transparency and heat generation characteristics.

According to an embodiment of the present disclosure, the first transparent heat generating body and the second transparent heat generating body may be manufactured by synthesizing graphene using a chemical vapor deposition method. The method for forming the graphene may be selected and employed, without limitation, from among methods typically used in the art for synthesizing graphene. For example, graphene may be synthesized on a first transparent substrate and a third transparent substrate by heating the first and third transparent substrates, and supplying hydrogen gas and a carbonization source. Examples of the carbonization source may include, but are not limited to, at least one of carbon monoxide, carbon dioxide, methane, ethane, ethylene, ethanol, acetylene, propane, butane, butadiene, pentane, pentene, cyclopentadiene, hexane, cyclohexane, benzene, and toluene.

According to an embodiment of the present disclosure, the chemical vapor deposition method may be performed at a temperature of 700° C. or more. Specifically, the chemical vapor deposition method may be performed at a temperature of 750° C. or more, 800° C. or more, 850° C. or more, 900° C. or more, or 1,000° C. or more. In addition, the chemical vapor deposition method may be performed at a temperature of 2,000° C. or less, 1,900° C. or less, 1,800° C. or less, 1,700° C. or less, 1,600° C. or less, or 1,500° C. or less. When the temperature at which the chemical vapor deposition method is performed is within the above-described range, the graphene can be stably formed, and the synthesized graphene can have excellent crystallinity.

According to an embodiment of the present disclosure, the graphene thin film may include a single graphene layer or a plurality of graphene layers. Specifically, the graphene thin film may include one to five layers, two to five layers, three to five layers, one to three layers, or two to three graphene layers. When the number of the graphene layers included in the graphene thin film is within the above-described range, surface resistance of the graphene thin film can be reduced to improve maximum temperature, heat generation efficiency, and heat dissipation characteristics of the graphene thin film. That is, the first and second transparent heat generating bodies can effectively heat an object and at the same time effectively reduce the thicknesses of the first and second transparent heat generating bodies. Through this, there is an advantage of reducing the thickness and weight of the variable heating apparatus and improving heating efficiency. Meanwhile, depending on a purpose for which the variable heating apparatus is used, the number of graphene layers included in the graphene thin film may be adjusted to 5 or more.

According to an embodiment of the present disclosure, the graphene thin film may be doped with a dopant. The heat generation efficiencies of the first and second transparent heat generating bodies can be increased by using the doped graphene. Specifically, the dopant may include an organic dopant or an inorganic dopant. Examples of the dopant may include, but are not limited to, one selected from the group consisting of ionic liquids, ionic gases, acid compounds, organic molecular compounds, and combinations thereof. For example, the dopant may include, but are not limited to, one selected from the group consisting of NO₂BF₄, NOBF₄, NO₂SbF₆, HCl, H₂PO₄, H₃CCOOH, H₂SO₄, HNO₃, PVDF, Nafion, AuCl₃, SOCl₂, Br₂, CH₃NO₂, dichlorodicyanoquinone, oxone, dimyristoylphosphatidylinositol, trifluoromethanesulfonimide, and combinations thereof.

According to an embodiment of the present disclosure, the resistance value per unit area of the graphene thin film may be 0.01 Ω/cm² or more and 5 Ω/cm² or less, 0.02 Ω/cm² or more and 5 Ω/cm² or less, 0.05 Ω/cm² or more and 5 Ω/cm² or less, 0.1 Ω/cm² or more and 5 Ω/cm² or less, 0.5 Ω/cm² or more and 5 Ω/cm² or less, 1 Ω/cm² or more and 5 Ω/cm² or less, 2 Ω/cm² or more and 5 Ω/cm² or less, 3 Ω/cm² or more and 5 Ω/cm² or less, 4 Ω/cm² or more and 5 Ω/cm² or less, 0.01 Ω/cm² or more and 1 Ω/cm² or less, 0.02 Ω/cm² or more and 1 Ω/cm² or less, 0.05 Ω/cm² or more and 1 Ω/cm² or less, 0.1 Ω/cm² or more and 1 Ω/cm² or less, or 0.5 Ω/cm² or more and 1 Ω/cm² or less.

When the resistance value per unit area of the graphene thin film is within the above-described range, the heat generation efficiency of the graphene thin film can be effectively improved. Through this, the variable heating apparatus can effectively heat the object. In addition, by adjusting the resistance value per unit area of the graphene thin film within the above-described range, the thickness of the transparent substrate provided with the graphene thin film can be reduced, so that it is possible to realize the variable heating apparatus with the thinner thickness.

For example, the size of the graphene thin film may be 100 cm² or more and 2,500 cm² or less. Specifically, the graphene thin film may have a size of 10 cm×10 cm or more and 40 cm×60 cm or less. In addition, when the graphene thin film includes one graphene layer, the graphene thin film having an area of the above-described size may have 200Ω or more and 400Ω or less. When the graphene thin film includes two graphene layers, the graphene thin film having an area of the above-described size may have 150Ω or more and 300Ω or less. When the graphene thin film includes three graphene layers, the graphene thin film having an area of the above-described size may have 100Ω or more and 200Ω or less. When the graphene thin film includes four graphene layers, the graphene thin film having an area of the above-described size may have 80Ω or more and 150Ω or less. When the graphene thin film includes five graphene layers, the graphene thin film having an area of the above-described size may have 60Ω or more and 100Ω or less.

According to an embodiment of the present disclosure, the graphene thin film may have a thickness of 0.35 nm or more and 2.0 nm or less. For example, when the graphene thin film includes a single (one) graphene layer, the graphene thin film may have a thickness of 0.35 nm. Also, when the graphene thin film includes five graphene layers, the graphene thin film may have a thickness of 1.75 nm. When the thickness of the graphene thin film is within the above-described range, heat generation efficiency of the transparent heat generating body can be increased, and manufacturing cost of the variable heating apparatus can be reduced.

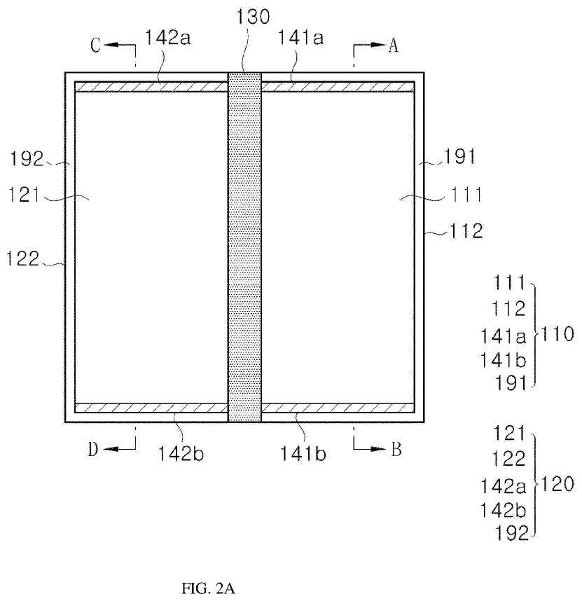

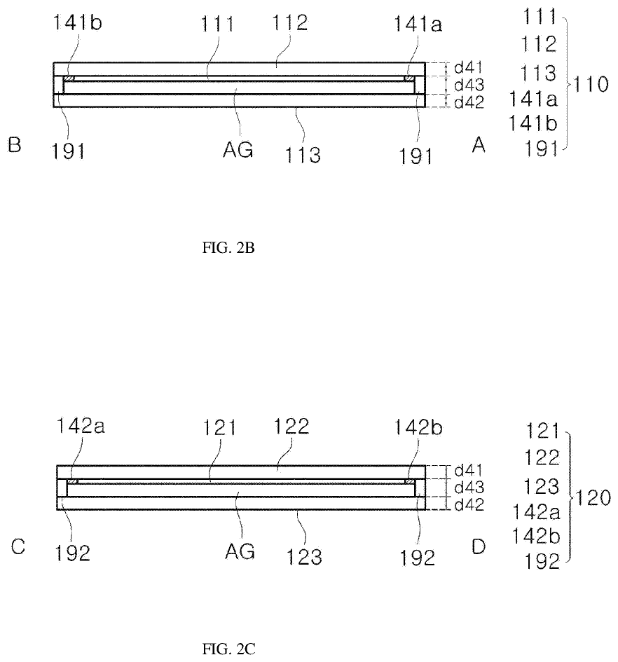

FIG. 2A shows a schematic top view of a variable heating apparatus according to an embodiment of the present disclosure, FIG. 2B shows a schematic cross-sectional view of the variable heating apparatus taken along line A-B in FIG. 2A, and FIG. 2C shows a schematic cross-sectional view of the variable heating apparatus taken along line C-D in FIG. 2A.

According to an embodiment of the present disclosure, the first transparent heating part may include a first transparent substrate provided with the first transparent heat generating body, and a second transparent substrate facing the first transparent substrate with the first transparent heat generating body interposed therebetween, and the second transparent heating part may include a third transparent substrate provided with the second transparent heat generating body, and a fourth transparent substrate facing the third transparent substrate with the second transparent heat generating body interposed therebetween, wherein the first transparent substrate and the second transparent substrate may be sealed such that an air gap is formed between the first transparent substrate and the second transparent substrate, and the third transparent substrate and the fourth transparent substrate may be sealed such that an air gap is formed between the third transparent substrate and the fourth transparent substrate.

Referring to FIGS. 2A to 2C, the first transparent heat generating body 111 may be provided on one surface of the first transparent substrate 112, and the second transparent substrate 113 may be provided such that it is spaced apart from and faces the first transparent substrate 112 with the first transparent heat generating body 111 interposed therebetween. That is, an air gap AG may be formed between the first transparent substrate 112 and the second transparent substrate 113, and the first transparent heat generating body 111 may be located within the air gap AG. In addition, the second transparent heat generating body 121 may be provided on one surface of the third transparent substrate 122, and the fourth transparent substrate 123 may be provided such that it is spaced apart from and faces the third transparent substrate 122 with the second transparent heat generating body 121 interposed therebetween. That is, an air gap AG may be formed between the third transparent substrate 122 and the fourth transparent substrate 123, and the second transparent heat generating body 121 may be located within the air gap AG.

The first transparent substrate provided with the first transparent heat generating body and the third transparent substrate provided with the second transparent heat generating body correspond to a portion for heating the object (heating portion), and the second transparent substrate and the fourth transparent substrate may correspond to a portion that does not heat the object (non-heating portion). In this regard, by forming the air gap between the first transparent substrate and the second transparent substrate, and forming the air gap between the third transparent substrate and the fourth transparent substrate, the heat emitted from the first and second transparent heat generating bodies can be effectively suppressed from being emitted to the second and fourth transparent substrates while, at the same time, effectively heating the object through the first and third transparent substrates. Through this, it is possible to further improve the in-use stability of the variable heating apparatus.

According to an embodiment of the present disclosure, transparent materials among materials used in the art which have a predetermined strength may be used as the first to fourth transparent substrates. For example, the first to fourth transparent substrates may be formed of glass or polymer film. In this case, the glass physically and/or chemically strengthened may be used. Examples of the polymer film may include, but are not limited to, at least one of polyethylene terephthalate (PET), poly(methylmethacrylate) (PMMA), polyvinylidene fluoride (PVDF), and polyaniline (PANI).

According to an embodiment of the present disclosure, the thickness ratio of the first transparent substrate and the second transparent substrate may be 1:0.1 to 1:10. Specifically, referring to FIGS. 2A and 2B, the ratio of the thickness d41 of the first transparent substrate 112 and the thickness d42 of the second transparent substrate 113 may be 1:0.1 to 1:8, 1:0.1 to 1:6, 1:1 to 1:4, 1:0.1 to 1:4, 1:0.1 to 1:2, 1:1 to 1:8, 1:1 to 1:6, or 1:1 to 1:3. More specifically, the thickness ratio of the first transparent substrate and the second transparent substrate may be 1:2 to 1:10, 1:2 to 1:8, 1:2 to 1:6, or 1:2 to 1:4. When the thickness ratio of the first transparent substrate and the second transparent substrate is within the aforementioned range, the heat generated from the first transparent heat generating body can be effectively transferred to and heat the object through the first transparent substrate, and the in-use stability of the variable heating apparatus can be improved by suppressing heat dissipation to the outside through the second transparent substrate. Preferably, the thickness of the second transparent substrate may be thicker than the thickness of the first transparent substrate.

Additionally, the thickness ratio of the third transparent substrate and the fourth transparent substrate may be 1:0.1 to 1:10. Specifically, referring to FIGS. 2A and 2C, the ratio of the thickness d41 of the third transparent substrate 122 and the thickness d42 of the fourth transparent substrate 123 may be 1:0.1 to 1:8, 1:0.1 to 1:6, 1:1 to 1:4, 1:0.1 to 1:4, 1:0.1 to 1:2, 1:1 to 1:8, 1:1 to 1:6, or 1:1 to 1:3. More specifically, the thickness ratio of the third transparent substrate and the fourth transparent substrate may be 1:2 to 1:10, 1:2 to 1:8, 1:2 to 1:6, or 1:2 to 1:4. When the thickness ratio of the third transparent substrate and the fourth transparent substrate is within the aforementioned range, the heat generated from the second transparent heat generating body can be effectively transferred to and heat the object through the third transparent substrate, and the in-use stability of the variable heating apparatus can be improved by suppressing heat dissipation to the outside through the fourth transparent substrate. Preferably, the thickness of the fourth transparent substrate may be thicker than the thickness of the third transparent substrate.

According to an embodiment of the present disclosure, the thickness of each of the first transparent substrate to the fourth transparent substrate may be 0.5 mm or more and 5 mm or less. Specifically, the thickness of each of the first transparent substrate to the fourth transparent substrate may be 0.5 mm or more and 4.5 mm or less, 0.5 mm or more and 4 mm or less, 0.5 mm or more and 3.5 mm or less, or 0.5 mm or more and 3 mm or less. When the thickness of each of the first transparent substrate to the fourth transparent substrate is within the above-described range, the variable heating apparatus can effectively heat the object, while enhancing the in-use stability, and improving ease of use through the effective reduction of the total thickness and weight of the variable heating apparatus.

According to an embodiment of the present disclosure, the ratio of the thickness of the first transparent heat generating body and the thickness of the first transparent substrate may be 1:0.1×10⁶ to 1:10×10⁶. Specifically, referring to FIGS. 2A and 2B, the ratio of the thickness of the graphene thin film included in the first transparent heat generating body 111 and the thickness d41 of the first transparent substrate 112 may be 1:0.1×10⁶ to 1:10×10⁶, 1:0.2×10⁶ to 1:9×10⁶, 1:0.5×10⁶ to 1:8.5×10⁶, 1:1×10⁶ to 1:7×10⁶, 1:2.5×10⁶ to 1:5.5×10⁶, 1:0.2×10⁶ to 1:2.5×10⁶, 1:0.25×10⁶ to 1:2×10⁶, 1:5×10⁶ to 1:10×10⁶, or 1:7.5×10⁶ to 1:10×10⁶. When the ratio of the thickness of the first transparent heat generating body and the thickness of the first transparent substrate is within the aforementioned range, the heat generated by the first transparent heat generating body can be easily transferred to the first transparent substrate, thereby effectively heating the object.

Additionally, the ratio of the thickness of the second transparent heat generating body and the thickness of the third transparent substrate may be 1:0.1×10⁶ to 1:10×10⁶. Specifically, referring to FIGS. 2A and 2C, the ratio of the thickness of the graphene thin film included in the second transparent heat generating body 121 and the thickness d41 of the third transparent substrate 122 may be 1:0.1×10⁶ to 1:10×10⁶, 1:0.2×10⁶ to 1:9×10⁶, 1:0.5×10⁶ to 1:8.5×10⁶, 1:1×10⁶ to 1:7×10⁶, 1:2.5×10⁶ to 1:5.5×10⁶, 1:0.2×10⁶ to 1:2.5×10⁶, 1:0.25×10⁶ to 1:2×10⁶, 1:5×10⁶ to 1:10×10⁶, or 1:7.5×10⁶ to 1:10×10⁶. When the ratio of the thickness of the second transparent heat generating body and the thickness of the third transparent substrate is within the aforementioned range, the heat generated by the second transparent heat generating body can be easily transferred to the third transparent substrate, thereby effectively heating the object.

According to an embodiment of the present disclosure, the first transparent heating part may include a first spacer which is provided between the first transparent substrate and the second transparent substrate to seal the first transparent substrate and the second transparent substrate, and the second transparent heating part may include a second spacer which is provided between the third transparent substrate and the fourth transparent substrate to seal the third transparent substrate and the fourth transparent substrate.

Referring to FIGS. 2A to 2C, a first spacer 191 may be provided between the first transparent substrate 112 and the second transparent substrate 113 to seal the first transparent substrate 112 and the second transparent substrate 113, thereby forming the air gap AG between the first transparent substrate 112 and the second transparent substrate 113. In addition, a second spacer 192 may be provided between the third transparent substrate 122 and the fourth transparent substrate 123 to seal the third transparent substrate 122 and the fourth transparent substrate 123, thereby forming the air gap AG between the third transparent substrate 122 and the fourth transparent substrate 123.

The first spacer may be provided on the peripheral portions of the first transparent substrate and the second transparent substrate to surround the first transparent heat generating body, and the second spacer may be provided on the peripheral portions of the third transparent substrate and the fourth transparent substrate to surround the second transparent heat generating body. The first spacer and the second spacer may be selected from among spacers typically used in the art, and, for example, may utilize silicone rubber. However, the materials of the first spacer and the second spacer are not limited thereto.

According to an embodiment of the present disclosure, each of the first spacer and the second spacer may have a thickness of 1 mm or more and 10 mm or less, 2.5 mm or more and 7.5 mm or less, 4 mm or more and 6 mm or less, 1 mm or more and 6 mm or less, 2 mm or more and 4 mm or less, 5 mm or more and 10 mm or less, or 6.5 mm or more and 8.5 mm or less. Referring to FIGS. 2A to 2C, when the thicknesses of the first spacer 191 and the second spacer 192 are within the aforementioned range, the air gaps may be stably formed between the first transparent substrate 112 and the second transparent substrate 113, and between the third transparent substrate 122 and the fourth transparent substrate 123, respectively. Through this, heat generated from the first and second transparent heat generating bodies can be effectively suppressed from being transferred to the second transparent substrate and the fourth transparent substrate, thereby enhancing the in-use stability of the variable heating apparatus.

According to an embodiment of the present disclosure, the ratio of the thickness of the second transparent substrate and the thickness of the first spacer may be 1:0.2 to 1:25. Specifically, referring to FIGS. 2A and 2B, the ratio of the thickness d42 of the second transparent substrate 113 and the thickness d43 of the first spacer 191 may be 1:0.3 to 1:20, 1:1 to 1:15, 1:3 to 1:10, 1:5 to 1:7, 1:0.2 to 1:10, 1:1 to 1:7.5, 1:3 to 1:5, 1:10 to 1:25, or 1:15 to 1:20. By adjusting the ratio of the thickness of the second transparent substrate and the thickness of the first spacer to the aforementioned range, the heat generated from the first transparent heat generating bodies can be effectively suppressed from being transferred to the second transparent substrate, thereby enhancing the in-use stability of the variable heating apparatus. In addition, the total thickness and weight of the variable heating apparatus may be easily adjusted by controlling the thickness of the second transparent substrate according to the adjustment of the thickness of the first spacer.

Additionally, the ratio of the thickness of the fourth transparent substrate and the thickness of the second spacer may be 1:0.2 to 1:25. Specifically, referring to FIGS. 2A and 2C, the ratio of the thickness d42 of the fourth transparent substrate 123 and the thickness d43 of the second spacer 192 may be 1:0.3 to 1:20, 1:1 to 1:15, 1:3 to 1:10, 1:5 to 1:7, 1:0.2 to 1:10, 1:1 to 1:7.5, 1:3 to 1:5, 1:10 to 1:25, or 1:15 to 1:20. By adjusting the ratio of the thickness of the fourth transparent substrate and the thickness of the second spacer to the aforementioned range, the heat generated from the second transparent heat generating body can be effectively suppressed from being transferred to the fourth transparent substrate, thereby enhancing the in-use stability of the variable heating apparatus. In addition, the total thickness and weight of the variable heating apparatus may be easily adjusted by controlling the thickness of the fourth transparent substrate according to the adjustment of the thickness of the second spacer.

According to an embodiment of the present disclosure, the ratio of the thickness of the first transparent heat generating body and the thickness of the first spacer may be 1:0.5×10⁶ to 1:30×10⁶. Specifically, referring to FIGS. 2A and 2B, the ratio of the thickness of the graphene thin film included in the first transparent heat generating body 111 and the thickness d43 of the first spacer 191 may be 1:0.5×10⁶ to 1:25×10⁶, 1:0.2×10⁶ to 1:20×10⁶, 1:0.5×10⁶ to 1:15×10⁶, 1:1×10⁶ to 1:10×10⁶, 1:2.5×10⁶ to 1:7.5×10⁶, 1:0.5×10⁶ to 1:10×10⁶, 1:1×10⁶ to 1:7×10⁶, or 1:2×10⁶ to 1:6×10⁶. When the ratio of the thickness of the first transparent heat generating body and the thickness of the first spacer is within the aforementioned range, the distance between the first transparent heat generating body and the second transparent substrate can be appropriately adjusted, so that the heat generated by the first transparent heat generating body can be easily transferred to the first transparent substrate and, at the same time, can be effectively suppressed from being transferred to the second transparent substrate.

Additionally, the ratio of the thickness of the second transparent heat generating body and the thickness of the second spacer may be 1:0.5×10⁶ to 1:30×10⁶. Specifically, referring to FIGS. 2A and 2C, the ratio of the thickness of the graphene thin film included in the second transparent heat generating body 121 and the thickness d43 of the second spacer 192 may be 1:0.5×10⁶ to 1:25×10⁶, 1:0.2×10⁶ to 1:20×10⁶, 1:0.5×10⁶ to 1:15×10⁶, 1:1×10⁶ to 1:10×10⁶, 1:2.5×10⁶ to 1:7.5×10⁶, 1:0.5×10⁶ to 1:10×10⁶, 1:1×10⁶ to 1:7×10⁶, or 1:2×10⁶ to 1:6×10⁶. When the ratio of the thickness of the second transparent heat generating body and the thickness of the second spacer is within the aforementioned range, the distance between the second transparent heat generating body and the fourth transparent substrate can be appropriately adjusted, so that the heat generated by the second transparent heat generating body can be easily transferred to the third transparent substrate and, at the same time, can be effectively suppressed from being transferred to the fourth transparent substrate.

According to an embodiment of the present disclosure, the air gap may contain an inert gas. Specifically, the air gap formed between the first transparent substrate and the second transparent substrate and the air gap formed between the third transparent substrate and the fourth transparent substrate may contain at least one inert gas selected from the group consisting of nitrogen, argon, and helium gases. More specifically, the air gap may be formed by filling at least one inert gas selected from the group consisting of nitrogen, argon, and helium gases between the first transparent substrate and the second transparent substrate or between the third transparent substrate and the fourth transparent substrate. By including an inert gas in the air gap, the oxidation of the graphene thin film included in the first and second transparent heat generating bodies can be prevented, thereby improving long-term reliability and durability of the variable heating apparatus.

According to an embodiment of the present disclosure, the first transparent heating part may further include an electrode connected to the first transparent heat generating body, and the second transparent heating part may further include an electrode connected to the second transparent heat generating body. Specifically, the first transparent heating part may include a pair of electrodes connected to the first transparent heat generating body, and the second transparent heating part may include a pair of electrodes connected to the second transparent heat generating body. In this case, the electrodes may be provided at ends of the transparent heat generating body, top portions of the transparent heat generating body, or bottom portions of the transparent heat generating body. However, the location of the electrode provided to the transparent heat generating body may be variously changed according to design.

FIGS. 2A to 2C show the variable heating apparatus according to an embodiment of the present disclosure in which a pair of electrodes 141a and 141b included in the first transparent heating part 110 are provided at opposite ends of the first transparent heat generating body 111 and a pair of electrodes 142a and 142b included in the second transparent heating part 120 are provided at opposite ends of the second transparent heat generating body 121. Meanwhile, unlike those shown in FIGS. 2A to 2C, when the electrode is provided on the bottom portion of the transparent heat generating body, the stacking sequence may be as follows: transparent substrate, electrode, transparent heat generating body, transparent substrate. In addition, when the electrode is provided on the top portion of the transparent heat generating body, the stacking sequence may be as follows: transparent substrate, transparent heat generating body, electrode, transparent substrate. Meanwhile, when the electrodes are provided on the top or bottom portions of the transparent heat generating body, the transparent heat generating body may be provided on the entire region of one surface of the transparent substrate except for the region where the spacer is provided.

The material of the electrode may be selected from those commonly used in the art. Further, the electrode may be formed in the form of a finely patterned structure.

Referring to FIGS. 2A to 2C, line A-B and line C-D may correspond to long axis directions of the first transparent heat generating body 111 and the second transparent heat generating body 121, and directions orthogonal to the lines A-B and C-D may correspond to short axis directions of the first transparent heat generating body 111 and the second transparent heat generating body 121. That is, the electrodes 141a, 141b, 142a, and 142b may be provided such that they are continuous on opposite ends of the first and second transparent heat generating bodies 111 and 121 along the short axis directions of the first and second transparent heat generating bodies 111 and 121.

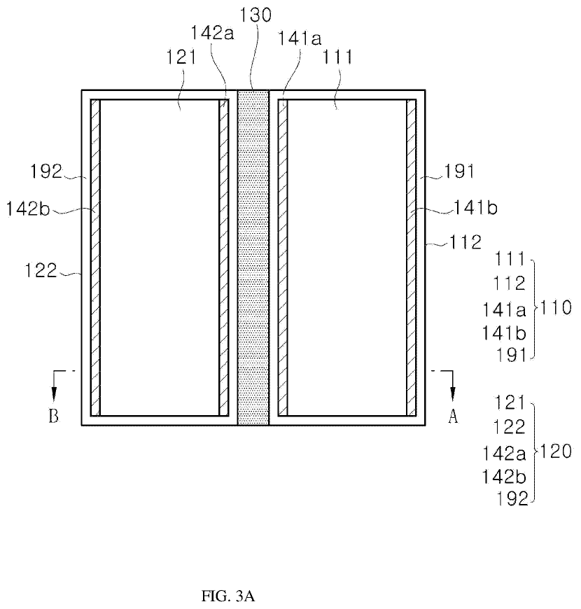

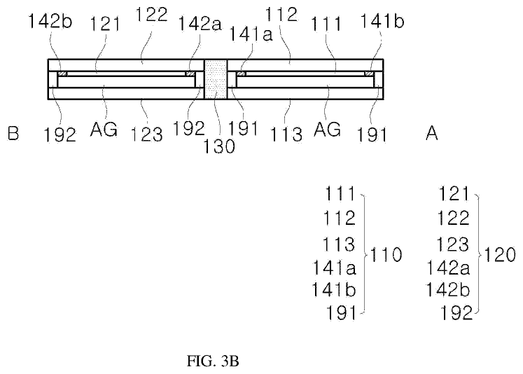

FIG. 3A shows a schematic top view of a variable heating apparatus according to an embodiment of the present disclosure, and FIG. 3B shows a schematic cross-sectional view of the variable heating apparatus taken along line A-B in FIG. 3A. Referring to FIGS. 3A and 3B, the direction of the line A-B may correspond to the short axis directions of the first transparent heat generating body 111 and the second transparent heat generating body 121, and the directions orthogonal to the line A-B may correspond to the long axis directions of the first transparent heat generating body 111 and the second transparent heat generating body 121.

According to an embodiment of the present disclosure, the electrodes may be provided along the long axis directions of the transparent heating part. Referring to FIGS. 3A and 3B, the electrodes 141a, 141b, 142a, and 142b may be provided such that they are continuous on opposite ends of the first and second transparent heat generating bodies 111 and 121 along the long axis directions of the first and second transparent heat generating bodies 111 and 121. By providing the electrodes continuously along the long axis directions of the transparent heat generating body, the heat generation efficiency and heat dissipation efficiency of the transparent heat generating body may be improved.

According to an embodiment of the present disclosure, the electrode may be a kind of a transparent electrode. By using the transparent electrode, transparency of the transparent heating part can be further ensured.

For example, the electrode may be a transparent electrode including indium tin oxide (ITO), graphene, or carbon nanotube (CNT). In this case, when the electrode includes graphene, the transparent heat generating body can be manufactured as a graphene integrated type by forming a graphene electrode through the formation of a fine pattern structure of graphene for electrode formation and then transferring the graphene layer.

On the other hand, by using, as the electrode, an electrode having a fine-sized pattern structure other than the transparent electrode so as not to be visually recognized by a user, it is possible to ensure the transparency of the transparent heating part.

According to an embodiment of the present disclosure, high-efficiency and uniform heat can be generated from the entire surface of the transparent heat generating body by forming an electrode having a fine pattern structure on the transparent heat generating body (graphene layer). For example, a plurality of electrodes may be formed in a fine pattern structure on the top portion and/or bottom portion of the graphene layer so that they can be connected in series or parallel, and in this case, the amount of generated heat can be increased.

In the case of the transparent heat generating body including the electrode having the fine pattern structure, after forming the electrode in the form of a fine pattern through a mask process, the graphene layer acting as the transparent heat generating body may be formed on the electrode formed in the form of the fine pattern. Alternatively, it is also possible to first form the graphene layer acting as the transparent heat generating body on one surface of the transparent substrate, and then form a finely patterned graphene film acting as the electrode on the graphene layer.

According to an embodiment of the present disclosure, the transparent heating part may further include a metal layer provided on the transparent substrate. That is, the first transparent heating part may include a first metal layer provided between the first transparent substrate and the first transparent heat generating body, and the second transparent heating part may include a second metal layer provided between the second transparent substrate and the second transparent heat generating body.

The metal layer may be provided on the entire surface or a partial region of the transparent substrate. With the help of the metal layer, even if a small number of graphene layers are transferred onto the transparent substrate, the heat generation efficiency and the heat dissipation efficiency can be improved by allowing electric current to flow more easily between both electrodes, and higher heat can be generated and the generated heat can be dissipated more quickly, by increasing the surface area and reducing the surface resistance (or sheet resistance).

The metal layer 130 may include, but is not limited to, one or more metals or alloys selected from the group consisting of Ni, Co, Fe, Pt, Au, Al, Cr, Cu, Mg, Mn, Mo, Rh, Si, Ta, Ti, W, U, V, Zr, brass, bronze, cupro-nickel, stainless steel, and Ge.

In addition, when the metal layer is formed on the transparent substrate, the metal layer may serve as a catalyst for forming the graphene layer, and the transparent heat generating body may be manufactured without a separate transfer process by directly forming the graphene layer by providing a reactive gas containing a carbon source and heat for reaction onto the transparent substrate with the metal layer formed thereon.

According to an embodiment of the present disclosure, a method of forming the transparent heat generating body (graphene) on the transparent substrate may be as follows.

First, a transparent substrate is prepared, and a graphene layer is formed on one surface of the transparent substrate. In order to form the graphene layer on the transparent substrate, the graphene layer formed on another substrate may be transferred onto the transparent substrate, or, as mentioned above, in the case where the metal layer has been formed on the transparent substrate, the graphene layer may be formed directly on the metal layer on the transparent substrate.

For example, by transferring, to one surface of the transparent substrate, the graphene layer formed by providing a reactive gas containing a carbon source and heat for reaction onto the metal catalyst, the graphene layer (transparent heat generating body) may be formed on the transparent substrate. While supplying the carbon source, such as, for example, carbon monoxide, carbon dioxide, methane, ethane, ethylene, ethanol, acetylene, propane, butane, butadiene, pentane, pentene, cyclopentadiene, hexane, cyclohexane, benzene, toluene or the like, in the gas phase, for example, when heat treatment is performed at a temperature of 300° C. to 2000° C., the carbon components present in the carbon source are combined to form hexagonal plate-like structures, thereby growing the graphene layer. The metal catalyst layer formed on the substrate may facilitate the growth of the graphene film thereon, and there is no particular restriction on the material for use in the metal catalyst layer. For example, the metal catalyst layer may be one or more metals or alloys selected from the group consisting of Ni, Co, Fe, Pt, Au, Al, Cr, Cu, Mg, Mn, Mo, Rh, Si, Ta, Ti, W, U, V, Zr, brass, bronze, cupro-nickel, stainless steel, and Ge. In addition, there is no particular restriction on the thickness of the metal catalyst layer, and it may be a thin film or a thick film. As a method of forming the graphene layer, a method commonly used in the art for graphene growth may be used without particular limitation, and for example, a chemical vapor deposition method may be used without limitation. Examples of the chemical vapor deposition method may include, but are not limited to, rapid thermal chemical vapor deposition (RTCVD), inductively coupled plasma-chemical vapor deposition (ICP-CVD), low pressure chemical vapor deposition (LPCVD), atmospheric pressure chemical vapor deposition (APCVD), metal organic chemical vapor deposition (MOCVD), and plasma-enhanced chemical vapor deposition (PECVD).

The process of growing the graphene layer may be performed under atmospheric pressure, low pressure, or vacuum. For example, when the process is performed under an atmospheric pressure condition, damage to graphene caused by collision with heavy argon (Ar) at high temperature can be minimized by using helium (He) or the like as a carrier gas. In addition, when the process is performed under an atmospheric pressure condition, there is an advantage in that a large-area graphene film can be manufactured through a simple process at low cost. Additionally, when the process is performed under a low pressure or vacuum condition and hydrogen (H₂) is used as an atmospheric gas, high-quality graphene can be synthesized by reducing the oxidized surface of the metal catalyst by treating it with increasing temperature. The graphene layer formed by the above-mentioned method may have a large area whose length(s) in the transverse direction and/or the longitudinal direction may range from about 1 mm or more to about 1000 m. Further, the graphene film has a homogeneous structure with almost no defects. The graphene layer manufactured by the above-mentioned method may include a single layer or multiple layers of graphene. As a non-limiting example, the thickness of the graphene film may be adjusted within the range of 1 layer to 100 layers.

Thereafter, the graphene layer may be transferred onto the transparent substrate by various processes. Any one of methods commonly used in the art for transferring and coating a graphene layer on a substrate may be used, without limitation, as the transfer method, and for example, a dry process, a wet process, a spray process, or a roll-to-roll process may be used.

The transfer method by the roll-to-roll process may be usefully used as the transfer method of a large-area graphene layer, and for example, in order to form the graphene layer as the transparent heat generating body, the large-area graphene layer may be transferred to the transparent substrate (transparent flexible substrate to be described below) or the like by the roll-to-roll process. Further, when the electrode is a transparent electrode including graphene, a graphene electrode fine pattern may be freely formed by transferring a graphene layer onto the transparent substrate using the roll-to-roll process.

The transfer method by the roll-to-roll process may include rolling a flexible substrate with the graphene film formed thereon and a target substrate in contact with the graphene film by means of a transfer roller to transfer the graphene film onto the target substrate, and, however, more specifically, it may include three steps. The three steps may include rolling a graphene formed on a graphene growth support and a flexible substrate in contact with the graphene by means of a first roller serving as a bonding roller to form a laminated structure of graphene growth support-graphene film-flexible substrate; transferring the graphene film onto the flexible substrate by etching the graphene growth support by impregnating the laminated structure into and allowing it to pass through an etching solution using a second roller; and transferring the graphene film onto a target substrate by rolling the flexible substrate with the graphene film transferred thereon and the target substrate in contact with the graphene film by means of a third roller as a transfer roller.

Finally, after the graphene layer is transferred and formed on the transparent substrate, the electrodes may be formed at opposite ends of the graphene layer or on top portions and/or bottom portions of the graphene layer.

According to an embodiment of the present disclosure, the folding part may utilize, without limitation, any one of structures used in the art which are capable of connecting the first transparent heating part and the second transparent heating part and moving the second transparent heating part with respect to the first transparent heating part. For example, the folding part may be hinge-coupled with the first and second transparent heating parts to allow the second transparent heating part to move pivotally with respect to the first transparent heating part. Also, the folding part may be formed of a material such as rubber having elasticity, so that the variable heating apparatus may be folded through elasticity of the folding part.

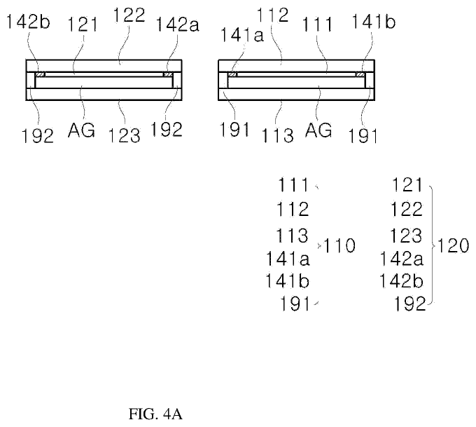

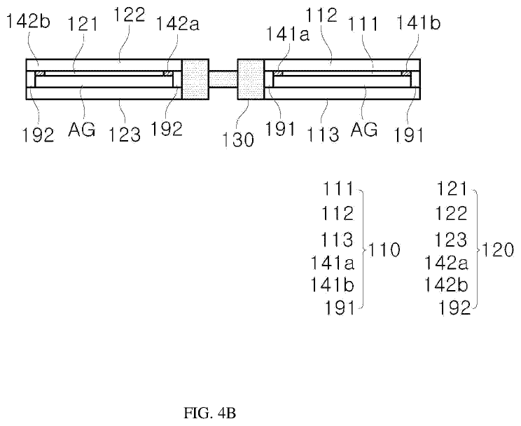

FIG. 4A shows a schematic view representing a variable heating apparatus according to an embodiment of the present disclosure with its folding part detached therefrom.

According to an embodiment of the present disclosure, the folding part may be attachable to and detachable from the first transparent heating part and the second transparent heating part. Referring to FIG. 3B, the variable heating apparatus may be provided with the folding part 130 attached to the first transparent heating part 110 and the second transparent heating part 120. On the other hand, referring to FIGS. 3B and 4A, by detaching the folding part 130 from the first transparent heating part 110 and the second transparent heating part 120, the first transparent heating part and the second transparent heating part can be separated from each other. Through this, the first transparent heating part and the second transparent heating part may be used separately. That is, the user may use it as the variable heating apparatus or as two heating apparatuses by attaching and detaching the folding part based on the size and type of the object.

FIG. 4B shows a variable heating apparatus according to an embodiment of the present disclosure in which the distance between the first transparent heating part and the second transparent heating part can be adjusted by deforming the folding part.

According to an embodiment of the present disclosure, the folding part may be adjusted between the first transparent heating part and the second transparent heating part. When the variable heating apparatus 100 is used in its folded state as shown in FIG. 1A, by adjusting the folding part 130 according to the thickness of the object to be heated, the object can be easily provided between the first transparent heating part 110 and the second transparent heating part 120. For example, when the variable heating apparatus in its folded state is used as a toaster, the folding part can be deformed according to the thickness of bread to be baked, and the bread can be easily positioned and baked between the first transparent heating part and the second transparent heating part.

In addition, when the variable heating apparatus 100 is used in its unfolded state as shown in FIG. 1B, the distance between the first transparent heating part 110 and the second transparent heating part 120 can be adjusted to improve user's operation convenience.

As the folding part is one capable of adjusting the distance between the first heating part and the second heating part, it may utilize any one of structures used in the art which are capable of adjusting the distance between two items while simultaneously connecting them to each other. For example, as shown in FIGS. 3B and 4B, the folding part 130 may be configured in a two-stage telescopic structure to adjust the distance between the first transparent heating part 110 and the second transparent heating part 120.

FIG. 5A shows a schematic top view of a variable heating apparatus according to an embodiment of the present disclosure, and FIG. 5B shows a schematic cross-sectional view of the variable heating apparatus taken along line A-B in FIG. 5A.

According to an embodiment of the present disclosure, the variable heating apparatus may further include a transparent flexible substrate, wherein the transparent flexible substrate may include a first transparent heating zone provided with the first transparent heating part; a second transparent heating zone provided with the second transparent heating part; and a folding zone located between the first transparent heating part and the second transparent heating part, and the folding part may be a portion of the transparent flexible substrate corresponding to the folding zone.

According to an embodiment of the present disclosure, the variable heating apparatus may include a transparent flexible substrate. Referring to FIGS. 5A and 5B, the variable heating apparatus 100 includes one transparent flexible substrate 150, a first transparent heating part 110, and a second transparent heating part 120, two transparent heating parts of which are provided on one surface of the transparent flexible substrate.

Referring to FIGS. 5A and 5B, the transparent flexible substrate 150 may include a first transparent heating zone HZ1 provided with the first transparent heating part 110; a second transparent heating zone HZ2 provided with the second transparent heating part 120; and a folding zone FZ located between the first transparent heating part 110 and the second transparent heating part 120, and the folding part may be a portion of the transparent flexible substrate 150 corresponding to the folding zone FZ. Electrodes 141a and 142a may be provided on the folding zone FZ of the transparent flexible substrate 50.

According to an embodiment of the present disclosure, a separate structure for folding the variable heating apparatus may be omitted by using a flexible transparent substrate as a substrate on which the first and second transparent heating parts are provided. That is, a portion of the transparent flexible substrate on which the first and second transparent heating parts are not provided may be utilized as the folding part.

A transparent and flexible substrate may be used as the transparent flexible substrate. For example, any one of a polyimide film, a polyester film, and the like may be used, without limitation, as the transparent flexible substrate.

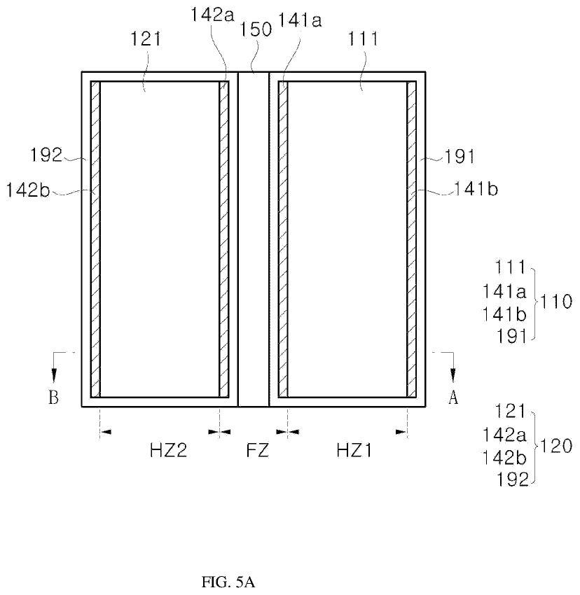

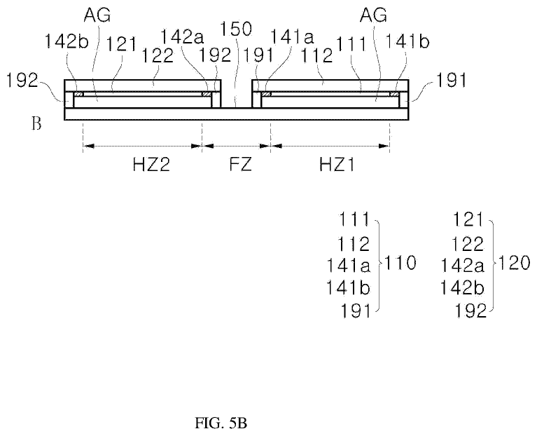

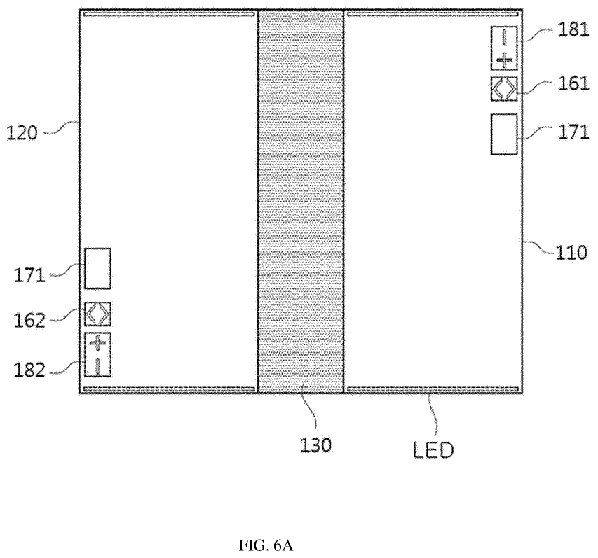

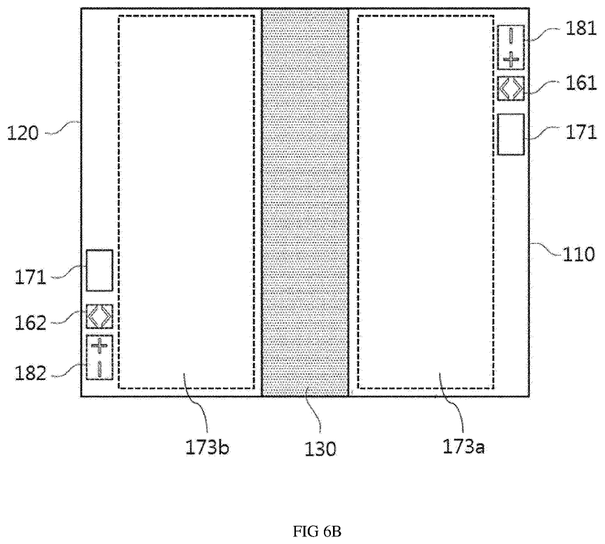

FIG. 6A shows a schematic plan view of a variable heating apparatus provided with a control part, a temperature display part, a driving time control part, and a light emitting device according to an embodiment of the present disclosure, and FIG. 6B shows a schematic plan view of a variable heating apparatus provided with a control part, a temperature display part, a driving time control part, and an image display part according to an embodiment of the present disclosure. In FIGS. 6A and 6B, for convenience of description, the configuration of the first transparent heat generating body and electrodes included in the first transparent heating part is omitted, and the configuration of the second transparent heat generating body and electrodes included in the second transparent heating part is omitted.

According to an embodiment of the present disclosure, the variable heating apparatus may further include a first temperature control part connected to the first transparent heat generating body to control the degree of heat generation of the first transparent heat generating body; and a second temperature control part connected to the second transparent heat generating body to control the degree of heat generation of the second transparent heat generating body.

Referring to FIGS. 6A and 6B, the first temperature control part 161 may be provided on the surface of the first transparent heating part 110, and the second temperature control part 162 may be provided on the surface of the second transparent heating part 120. Any one of configurations for adjusting the driving temperature of a heating apparatus used in the art may be employed, without limitation, as the first and second temperature control parts 161 and 162.

The first temperature control part may be connected to the first transparent heat generating body to control a driving temperature thereof, and the second temperature control part may be connected to the second transparent heat generating body to control a driving temperature thereof. That is, the driving temperatures of the first and second transparent heat generating bodies may be independently controlled.

According to an embodiment of the present disclosure, the variable heating apparatus may further include a first display part connected to the first transparent heat generating body to display driving information including temperature and driving time of the first transparent heat generating body; and a second display part connected to the second transparent heat generating body to display driving information including temperature and driving time of the second transparent heat generating body. Referring to FIGS. 6A and 6B, the first display part 171 may be provided in the first transparent heating part 110, and the second display part 172 may be provided in the second transparent heating part 120.

The display part may be connected to the transparent heat generating body to display driving information of the transparent heat generating body to the user, and may employ any one of display devices used in the art. In particular, by using a transparent display device as the display part, the transparency of the transparent heating part can be secured.

The variable heating apparatus may further include a temperature sensor part connected to the transparent heat generating body to measure the temperature of the transparent heat generating body, and the display part may display the temperature of the transparent heat generating body, interworking with the temperature sensor unit. The temperature of the transparent heat generating body displayed on the display part may be displayed in various forms capable of displaying temperature information to the user in numbers, gauges, colors, or the like.

According to an embodiment of the present disclosure, each of the first display part and the second display part may include a light emitting device that changes its color according to the temperature of a transparent heat generating body. Referring to FIG. 6A, the light emitting devices (LEDs) may be provided at opposite ends of the first and second transparent heating parts 110 and 120. The light emitting device may be selected for use from any one of light emitting devices used in the art, and for example, may use an OLED device.

The light emitting device may express different colors according to the temperature of the transparent heat generating body, interworking with the temperature sensor part. For example, when the temperature of the transparent heat generating body is low, the light emitting device may be set to emit blue light; when the temperature of the transparent heat generating body rises to some extent, the light emitting device may be set to emit green light; and when the temperature of the transparent heat generating body becomes higher, the light emitting device may be set to emit red light.

According to an embodiment of the present disclosure, the variable heating apparatus may further include a first driving time control part connected to the first transparent heat generating body to control the driving time of the first transparent heat generating body; and a second driving time control part connected to the second transparent heat generating body to control the driving time of the second transparent heat generating body. Referring to FIGS. 6A and 6B, the first driving time control part 181 may be provided in the first transparent heating part 110, and the second driving time control part 182 may be provided in the second transparent heating part 120. The driving time of the transparent heat generating body may be set in advance through the driving time control part, and the set time may be displayed through the display part.

According to an embodiment of the present disclosure, at least one of the first transparent heating part and the second transparent heating part may further include an image display part for outputting an image. Referring to FIG. 6B, the first transparent heating part 110 may include a first image display part 173a, and the second transparent heating part 120 may include a second image display part 173b.

The image display part may output an image preset by the user. For example, the image display part may output various images such as natural scenery, a specific building, a bonfire, a furnace, and the like. In particular, by using a transparent display device as the image display part, the transparency of the transparent heating part can be secured. When the image display part is provided in the first transparent heating part, the image display part may be provided in an air gap space formed between the first transparent substrate and the second transparent substrate. For example, the image display part may be provided on the second transparent substrate to be located facing the first transparent heat generating body.

According to an embodiment of the present disclosure, the first transparent heating part may include a first transparent molding part provided on the first transparent heat generating body, and the second transparent heating part may include a second transparent molding part provided on the second transparent heat generating body. The transparent molding part may be a member capable of molding an object to be heated into a predetermined shape. For example, the first and second transparent molding parts may be a waffle-shaped film, a fish-shaped bun-shaped film or the like. The shape of the object being heated through the first and second transparent heating parts may be molded using the first and second transparent molding parts. The first and second transparent molding parts may be attachable to and detachable from the first and second transparent heating parts. The first and second transparent molding parts may be made of a material that is transparent and has excellent thermal conductivity.

According to an embodiment of the present disclosure, optical transmittances of the first transparent heating part and the second transparent heating part may be 50% or more and 99% or less. Specifically, the optical transmittances of the first and second transparent heating parts may be 60% or more and 99% or less, 70% or more and 99% or less, 80% or more and 95% or less, or 85% or more and 90% or less. In this regard, the optical transmittances of the first and second transparent heating parts may be measured at a wavelength of 550 nm. Therefore, since the first and second transparent heating parts have excellent optical transmittances, the state of the object being heated by the first and second transparent heating parts can be easily observed.

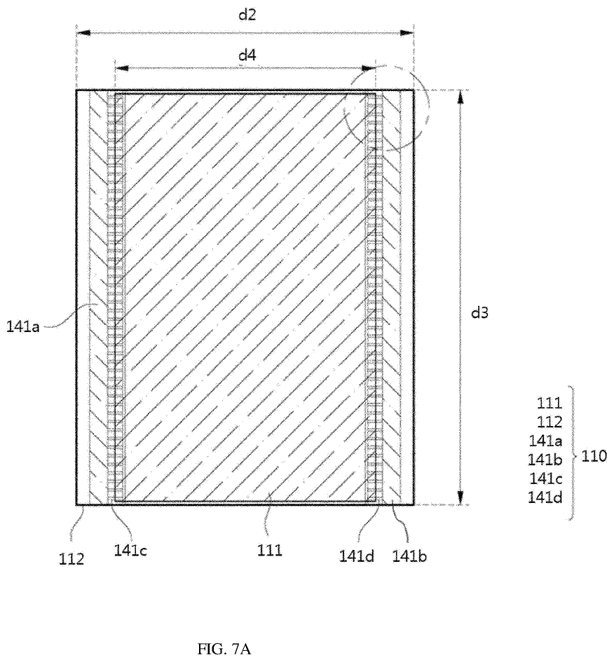

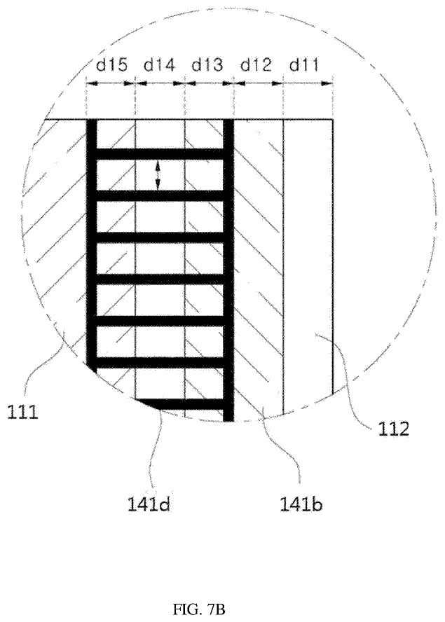

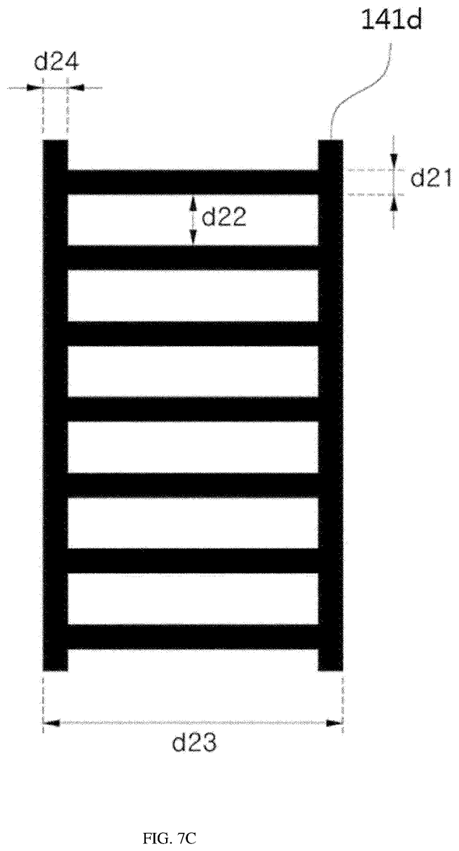

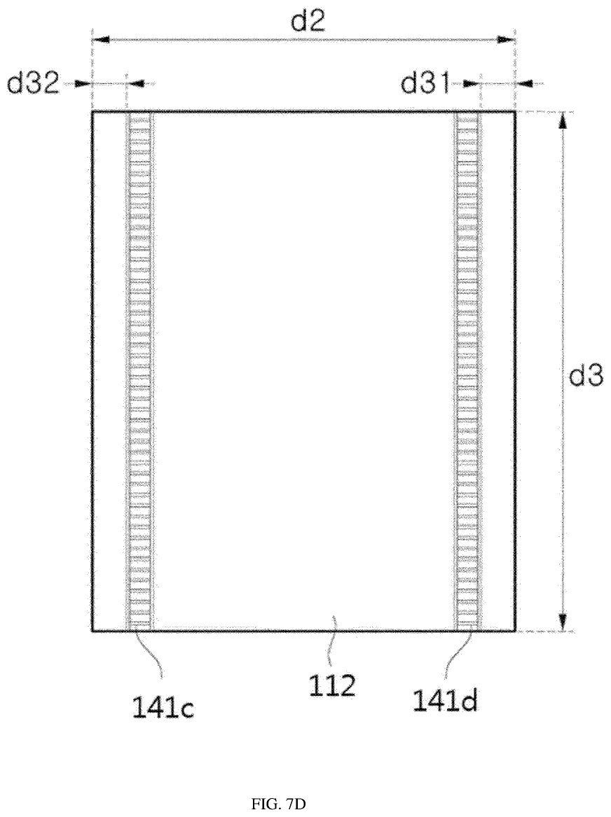

FIGS. 7A to 7D show diagrams illustrating electrodes included in a variable heating apparatus according to an embodiment of the present disclosure. Specifically, the diagrams shown in FIGS. 7A to 7D are focused on the first transparent heating part, and the second transparent heating part may also include the same structure as the electrode structure shown in FIGS. 7A to 7D. Meanwhile, the shape of the electrode according to an embodiment of the present disclosure is not limited to that shown in FIGS. 7A to 7D.

FIG. 7A shows a top view of the first transparent heating part 110 including the first electrode 141a, the second electrode 141b, a first auxiliary electrode 141c, a second auxiliary electrode 141d, and a first transparent heat generating body 111, FIG. 7B shows an enlarged view of the region circled in FIG. 7A, FIG. 7C shows an enlarged view of the second auxiliary electrode 141d, and FIG. 7D shows the shapes of the first and second auxiliary electrodes 141c and 141d provided on the first transparent substrate 112.

Referring to FIG. 7A, the long side d3 of the first transparent heating part 110 may have a length of 200 mm or more and 400 mm or less, and the short side d2 of the first transparent heating part 110 may have a length of 150 mm or more and 350 mm or less. When the lengths of the long side d3 and the short side d2 of the first transparent heating part 110 are within the aforementioned ranges, the variable heating apparatus may have excellent portability and storability. However, the lengths of the long side and the short side of the first transparent heating part may be set differently from the aforementioned ranges according to the intended use.

Referring to FIG. 7A, the length ratio of the short side d2 of the first transparent substrate 112 and the width d4 of the first transparent heat generating body 111 may be 1:0.5 to 1:0.9. When the length ratio of the short side d2 of the first transparent substrate 112 and the width d4 of the first transparent heat generating body 111 is within the aforementioned range, the first transparent heating part 110 can effectively heat the object. The width d4 of the first transparent heat generating body 111 may be 130 mm or more and 180 mm or less.

Referring to FIGS. 7A to 7D, the first and second auxiliary electrodes 141c and 141d may be provided on the first transparent substrate 112, and the first transparent heat generating body 111 and the first and second electrodes 141a and 141b may be provided on the first and second auxiliary electrodes 141c and 141d. On the other hand, the first transparent heat generating body 111 and the first and second electrodes 141a and 141b may be provided on the first transparent substrate 112, and the first and second auxiliary electrodes 141c and 141d may be provided on the first transparent heat generating body 111 and the first and second electrodes 141a and 141b.

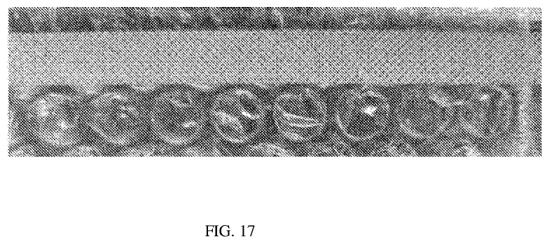

FIG. 17 shows a photographic image of a silver (Ag) electrode formed in a grid pattern as an auxiliary electrode on glass, which is a transparent substrate, according to an embodiment of the present disclosure.

According to an embodiment of the present disclosure, the first and second auxiliary electrodes may be provided in a ladder shape or grid shape.

According to an embodiment of the present disclosure, the resistance value per length of each of the first auxiliary electrode and the second auxiliary electrode may be 0.001 Ω/cm or more and 4 Ω/cm or less, 0.003 Ω/cm or more and 3.5 Ω/cm or less, 0.01 Ω/cm or more and 3 Ω/cm or less, 0.05 Ω/cm or more and 2.5 Ω/cm or less, 0.1 Ω/cm or more and 2 Ω/cm or less, 0.1 Ω/cm or more and 2 Ω/cm or less, 0.1 Ω/cm or more and 1.5 Ω/cm or less, or 0.1 Ω/cm or more and 1 Ω/cm or less. For example, based on the first auxiliary electrode (second auxiliary electrode) of 30 cm long, the resistance value may be 0.1Ω or more and 100Ω or less, 1Ω or more and 80Ω or less, 2Ω or more and 50Ω or less, or 3Ω or more and 30Ω or less.

When the resistance value of each of the first auxiliary electrode and the second auxiliary electrode is within the aforementioned range, the first transparent heat generating body can be connected to the first electrode through the first auxiliary electrode and the first transparent heat generating body can be connected to the second electrode through the second auxiliary electrode, so that an electrical current can be efficiently applied to the first transparent heat generating body, thereby improving the heat generation efficiency of the first transparent heat generating body.

Each of the first auxiliary electrode and the second auxiliary electrode may have a height (or thickness) of 10 nm or more and 3 μm or less, or 100 nm or more and 3 μm or less. When the height of each of the first auxiliary electrode and the second auxiliary electrode is within the aforementioned range, an electrical current can be efficiently applied to the first transparent heat generating body, thereby improving the heat generation efficiency of the first transparent heat generating body.

The first auxiliary electrode and the second auxiliary electrode may be manufactured using an electrode material used in the art, and for example, by using silver (Ag), the first auxiliary electrode and the second auxiliary electrode may be manufactured. Also, the first electrode and the second electrode may be manufactured using an electrode material used in the art, and for example, by using copper (Cu), the first electrode and the second electrode may be manufactured.

According to an embodiment of the present disclosure, the resistance value per length of each of the first electrode and the second electrode may be 0.01 Ω/cm or more and 2 Ω/cm or less, 0.05 Ω/cm or more and 1.5 Ω/cm or less, or 0.1 Ω/cm or more and 1 Ω/cm or less. For example, based on the first electrode (second electrode) of 30 cm long, the resistance value may be 0.1Ω or more and 10Ω or less. When the resistance value of each of the first electrode and the second electrode is within the aforementioned range, an electrical current can be efficiently applied to the first transparent heat generating body, thereby improving the heat generation efficiency of the first transparent heat generating body. Further, each of the first electrode and the second electrode may have a height (or thickness) of 0.5 μm or more and 3 μm or less. When the height of each of the first electrode and the second electrode is within the aforementioned range, an electrical current can be efficiently applied to the first transparent heat generating body, thereby improving the heat generation efficiency of the first transparent heat generating body.

Referring to FIGS. 7A to 7D, the first transparent heat generating body 111 may be provided between the first and second auxiliary electrodes 141c and 141d, and the first transparent heat generating body 111 may be provided to overlap the first and second auxiliary electrodes 141c and 141d. Meanwhile, the first transparent heat generating body 111 may be provided to be spaced apart from the first and second electrodes 141a and 141b. That is, the first electrode 141a may be connected to the first transparent heat generating body 111 through the first auxiliary electrode 141c, and the second electrode 141b may be connected to the first transparent heat generating body 111 through the second auxiliary electrode 141d.

As described above, the first transparent heat generating body may be connected to the first electrode through the first auxiliary electrode and the first transparent heat generating body may be connected to the second electrode through the second auxiliary electrode, so that an electrical current can be efficiently applied to the first transparent heat generating body, thereby improving the heat generation efficiency of the first transparent heat generating body.

Referring to FIGS. 7A to 7D, the distance d11 between the end of the first transparent substrate 112 and the second electrode 141b may be 3 mm or more and 10 mm or less. This distance d11 may be equal to the width of the first spacer. Additionally, a length ratio of the short side d2 of the first transparent substrate 112 and the distance d11 may be 1:0.01 to 1:0.05. The distance d12 between the end of the first transparent substrate 112 and the second auxiliary electrode 141d may be 3 mm or more and 10 mm or less. Additionally, a length ratio of the short side d2 of the first transparent substrate 112 and the distance d12 may be 1:0.01 to 1:0.05. The distance d13 between the distal end of the second electrode 141b from the end of the first transparent substrate 112 and the proximal end of the second auxiliary electrode 141d from the end of the first transparent substrate 112 may be 3 mm or more and 10 mm or less. Additionally, a length ratio of the short side d2 of the first transparent substrate 112 and the distance d13 may be 1:0.01 to 1:0.05. The distance d14 between the first transparent heat generating body 111 and the second electrode 141d may be 3 mm or more and 10 mm or less. Additionally, a length ratio of the short side d2 of the first transparent substrate 112 and the distance d14 may be 1:0.01 to 1:0.05. A distance d15 between the distal end of the second auxiliary electrode 141d from the end of the first transparent substrate 112 and the first transparent heat generating body 111 may be 3 mm or more and 10 mm or less. Additionally, a length ratio of the short side d2 of the first transparent substrate 112 and the distance d15 may be 1:0.01 to 1:0.05.

When the lengths of the distances d11 to d15 are within the aforementioned range, an electrical current can be effectively applied to the first transparent heat generating body. In addition, when the length ratio between each of the distances d11 to d15 and the short side of the first transparent substrate is within the aforementioned range, an electrical current can be effectively applied to the first transparent heat generating body. The lengths of the distances d11 to d15 may be the same as or different from each other. Meanwhile, the lengths of the distances d11 to d15 may be adjusted to lengths other than the above-described range depending on the use of the variable heating apparatus.

Referring to FIG. 7C, the second auxiliary electrode 141d may have a ladder shape. However, the shape of the second auxiliary electrode 141d is not limited to that shape. Referring to FIGS. 7A to 7C, a distance d21 in the second auxiliary electrode 141d may be 2 mm or more and 5 mm or less. Additionally, a length ratio of the long side d3 of the first transparent substrate 112 and the distance d21 may be 1:0.01 to 1:0.03. In the second auxiliary electrode 141d, a distance d22 may be 1 mm or more and 5 mm or less. Additionally, a length ratio of the long side d3 of the first transparent substrate 112 and the distance d22 may be 1:0.005 to 1:0.02. In the second auxiliary electrode 141d, a distance d23 may be 7 mm or more and 20 mm or less. Additionally, a length ratio of the short side d2 of the first transparent substrate 112 and the distance d23 may be 1:0.005 to 1:0.02. In the second auxiliary electrode 141d, a distance d24 may be 2 mm or more and 5 mm or less. Additionally, a length ratio of the short side d2 of the first transparent substrate 112 and the distance d24 may be 1:0.01 to 1:0.03.

Referring to FIGS. 7A to 7D, the first and second auxiliary electrodes 141c and 141d may be continuously provided along the long side d3 direction of the first transparent substrate 112. In order to form the first and second auxiliary electrodes 141c and 141d, an ink for forming an electrode may be printed on the first transparent substrate 112. For example, an ink containing silver (Ag) may be printed on the first transparent substrate 112. Specifically, an ink containing silver nanoparticles may be used. In addition, copper electrodes may be used as the first and second electrodes 141a and 141b. In FIG. 7D, a distance d32 between the end of the first transparent substrate 112 and the end of the first auxiliary electrode 141c may be equal to a distance d31 between the end of the first transparent substrate 112 and the end of the second auxiliary electrode 141d. In this regard, the distance d31 between the end of the first transparent substrate 112 and the end of the second auxiliary electrode 141d is equal to the sum of the distances d11 and d12 shown in FIG. 7B.

According to an embodiment of the present disclosure, the variable heating apparatus may further include an additional transparent heating part and an additional folding part. For example, the variable heating apparatus may include the first transparent heating part, the second transparent heating part, and a third transparent heating part, and may include the first folding part provided between the first transparent heating part and the second transparent heating part, and a second folding part provided between the second transparent heating part and the third transparent heating part. In this case, the variable heating apparatus may be deformed into a Z shape, and the first transparent heating part, the second transparent heating part, and the third transparent heating part may be folded to overlap each other. Further, the variable heating apparatus may include the first transparent heating part, the second transparent heating part, the third transparent heating part, and a fourth transparent heating part, and may include the first folding part provided between the first transparent heating part and the second transparent heating part, the second folding part provided between the second transparent heating part and the third transparent heating part, and a third folding part provided between the third transparent heating part and the fourth transparent heating part. In this case, the variable heating apparatus may be deformed into a W shape, and the first transparent heating part, the second transparent heating part, the third transparent heating part, and the fourth transparent heating part may be folded to overlap each other.

According to an embodiment of the present disclosure, the first heating part may be manufactured in the following method, and the second heating part may also be manufactured in the same method. However, the method of manufacturing the first heating part is not limited to that method.

First, a one-layer graphene layer may be synthesized on a thermal release tape (TRT) in the above-described method, and the graphene layer synthesized on the TRT may be laminated on and brought into contact with a glass, i.e., a transparent substrate, and transferred thereto, and the glass/graphene layer/TRT laminated structure may be heat-treated at a temperature of 150° C. for 1 minute, and then the TRT may be peeled off therefrom. Through this, it is possible to provide the graphene layer on the glass. Meanwhile, when a plurality of graphene layers needs to be formed on the glass, the above-described method may be repeated to form multiple graphene layers on the glass.

Thereafter, the glass with the graphene layer provided thereon may be placed in a silver electrode printing apparatus (available from ENJET company, Gyeonggi-do, Korea), and an ink containing silver (Ag) may be output to output a pattern having a set thickness and length. Thereafter, the ink may be cured at 200° C. for 30 minutes to 1 hour to form the first and second auxiliary electrodes. Thereafter, by attaching copper foil, the first and second electrodes may be manufactured. Through this, it is possible to manufacture a heating part provided with a glass as a transparent substrate, a graphene layer as a transparent heat generating body, an electrode, and an auxiliary electrode.

Thereafter, a silicone packing may be arranged on the peripheral region of the glass for the heating part, a new glass may be placed on the silicone packing to form a sandwich structure, an inert gas may be filled, and a sealing treatment may be performed to finally manufacture the heating part. For the sealing treatment, an adhesive or an adhesive film (insulation adhesive film, PI adhesive film or the like) may be used.

Meanwhile, silver electrodes (first and second auxiliary electrodes) may be formed on the glass through the above-described method, and the graphene layer may be transferred onto the glass on which the silver electrodes have been formed using the above-described method. Then, a copper foil may be attached along the edge of the silver electrode. Thereafter, the heating part may be manufactured by performing the sealing treatment in the same manner as described above.

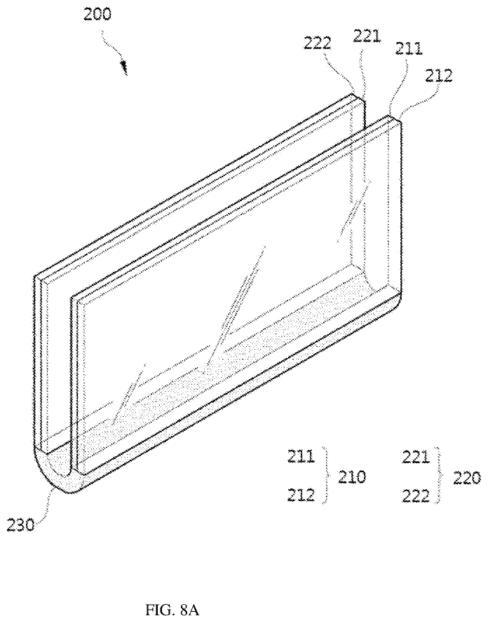

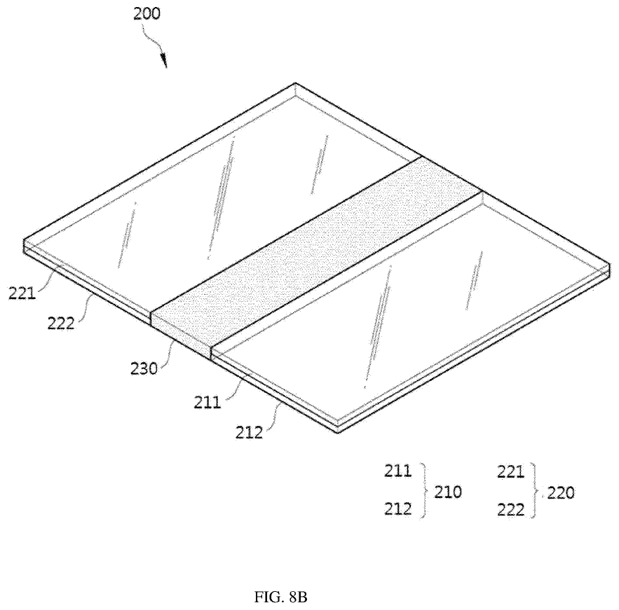

FIG. 8A shows a schematic view in which a variable heating apparatus according to an embodiment of the present disclosure is in its folded state, and FIG. 8B shows a schematic view in which the variable heating apparatus is in its unfolded state.

Hereinafter, the present embodiment will be described mainly in terms of differences compared to the previous embodiments, and parts omitted from explanation will be replaced by the previous contents. It should be noted that this can also be applied to other embodiments to be described below.

Referring to FIGS. 8A and 8B, the variable heating apparatus 200 includes a first transparent heating part 210, a second transparent heating part 220, and a folding part 230. The first transparent heating part 210 includes a first transparent heat generating body 211 and a first transparent substrate 212, and the second transparent heating part 220 includes a second transparent heat generating body 221 and a second transparent substrate 222.

The present embodiment corresponds to one in which the first and second transparent heating parts do not include an air gap in contrast to the above-described embodiments.

According to an embodiment of the present disclosure, the first transparent heating part may further include a first transparent substrate provided with the first transparent heat generating body, and an electrode connected to the first transparent heat generating body, and the second transparent heating part may further include a second transparent substrate provided with the second transparent heat generating body, and an electrode connected to the second transparent heat generating body.

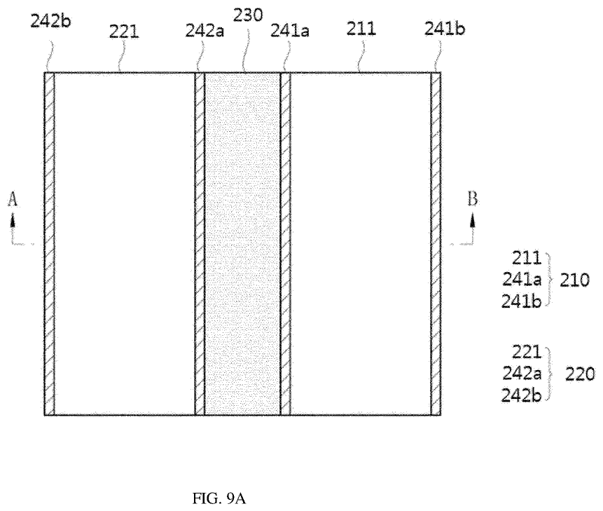

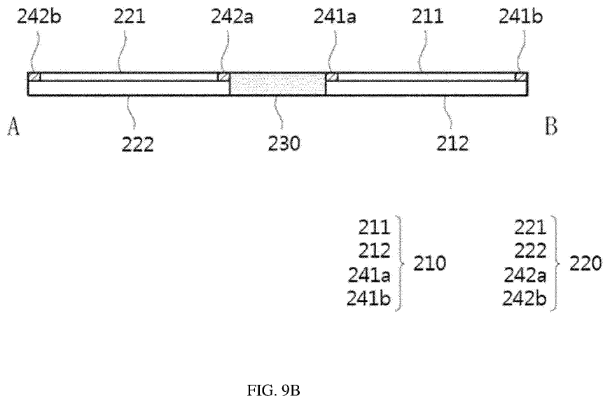

FIG. 9A shows a schematic top view of a variable heating apparatus according to an embodiment of the present disclosure, and FIG. 9B shows a schematic cross-sectional view of the variable heating apparatus taken along line A-B in FIG. 9A.

Referring to FIGS. 9A and 9B, the first transparent heat generating body 211 may be provided on the upper surface of the first transparent substrate 212, and the second transparent heat generating body 221 may be provided on the upper surface of the second transparent substrate 222. In this case, the first transparent heat generating body 211 may be provided on the entire one surface of the first transparent substrate 212, or may be provided on a portion of the one surface of the first transparent substrate 212. Additionally, the second transparent heat generating body 221 may be provided on the entire one surface of the second transparent substrate 222, or may be provided on a portion of the one surface of the second transparent substrate 222.

According to an embodiment of the present disclosure, the electrodes may be provided along the long axis directions of the transparent heating part. Referring to FIGS. 9A and 9B, line A-B may correspond to short axis directions of the first transparent heat generating body 211 and the second transparent heat generating body 221. That is, the electrodes 241a, 241b, 242a, and 242b may be provided such that they are continuous on opposite ends of the first and second transparent heat generating bodies 211 and 221 along the long axis directions of the first and second transparent heat generating bodies 211 and 221. By providing the electrodes continuously along the long axis directions of the transparent heat generating body, the heat generation efficiency and heat dissipation efficiency of the transparent heat generating body may be improved.

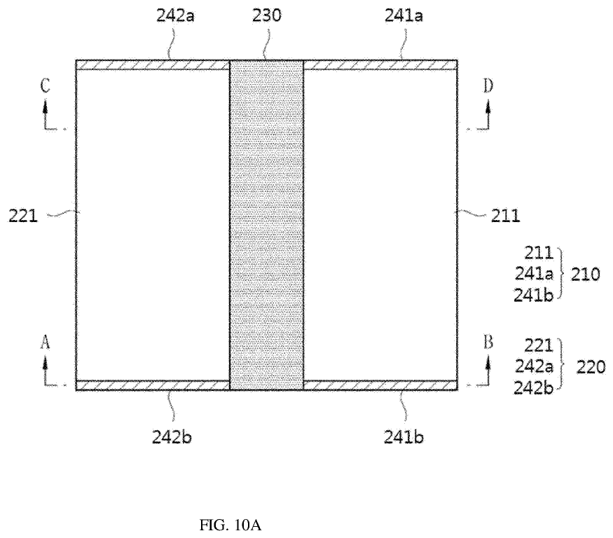

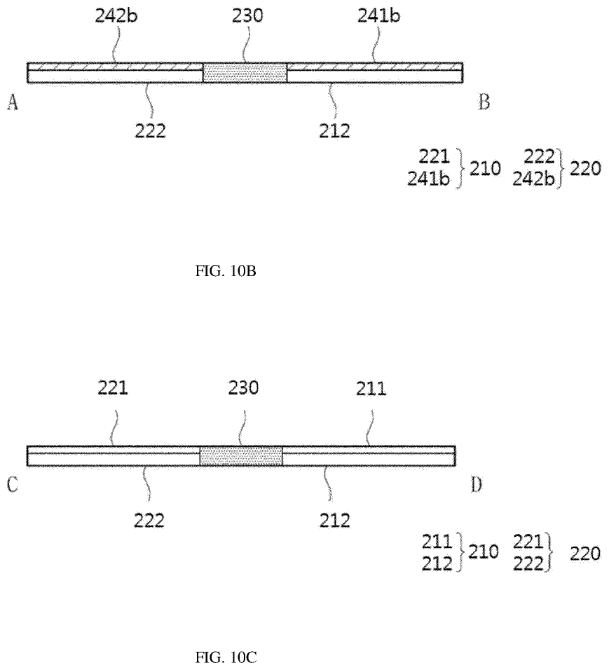

FIG. 10A shows a schematic top view of a variable heating apparatus according to an embodiment of the present disclosure, FIG. 10B shows a schematic cross-sectional view of the variable heating apparatus taken along line A-B in FIG. 10A, and FIG. 10C shows a schematic cross-sectional view of the variable heating apparatus taken along line C-D in FIG. 10A.

Referring to FIGS. 10A to 10C, lines A-B and C-D may correspond to short axis directions of the first transparent heat generating body 211 and the second transparent heat generating body 221. That is, the electrodes 241a, 241b, 242a, and 242b may be provided such that they are continuous on opposite ends of the first and second transparent heat generating bodies 211 and 221 along the short axis directions of the first and second transparent heat generating bodies 211 and 221.

FIG. 11 shows a schematic cross-sectional view of a variable heating apparatus provided with a transparent auxiliary layer according to an embodiment of the present disclosure.

According to an embodiment of the present disclosure, the first transparent heating part may further include a first transparent auxiliary layer provided on the first transparent heat generating body and the first transparent substrate, and the second transparent heating part may further include a second transparent auxiliary layer provided on the second transparent heat generating body and the second transparent substrate. Referring to FIG. 11, the first transparent heating part 210 may have a laminated structure of the first transparent substrate 212, the first transparent auxiliary layer 213 and the first transparent heat generating body 211, and the second transparent heating part 220 may have a laminated structure of the second transparent substrate 222, the second transparent auxiliary layer 223 and the second transparent heat generating body 211.

The transparent auxiliary layer may be a member provided to effectively introduce the transparent heat generating body onto the transparent substrate. For example, when the transparent substrate is glass, the surface of the glass is smooth, so it may not be easy to transfer the graphene layer onto the glass in the above-described method. Thus, by introducing the transparent auxiliary layer on the glass, the graphene layer can be more easily introduced on the transparent substrate. In addition, the transparent auxiliary layer may be provided between the transparent substrate and the transparent heat generating body, so that it can prevent heat generated from the transparent heat generating body from being emitted to the outside through the transparent substrate, thereby improving heating efficiency and user's operation convenience.

A transparent polymer film may be used as the first and second transparent auxiliary layers. For example, the transparent auxiliary layer may include at least one of a PET film, a PMMA film, a PVDF film, and a PANI film, but the type of the polymer film is not limited to them.

FIGS. 12A and 12B schematically illustrate states in which a folding part of a variable heating apparatus according to an embodiment of the present disclosure is attached and detached.

As described in the foregoing embodiment, the folding part may be attachable to and detachable from the first transparent heating part and the second transparent heating part.

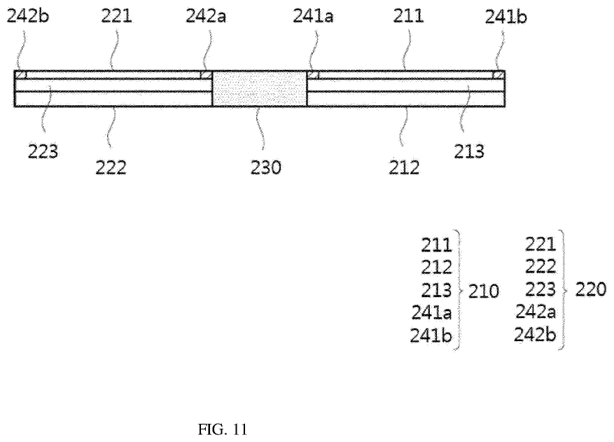

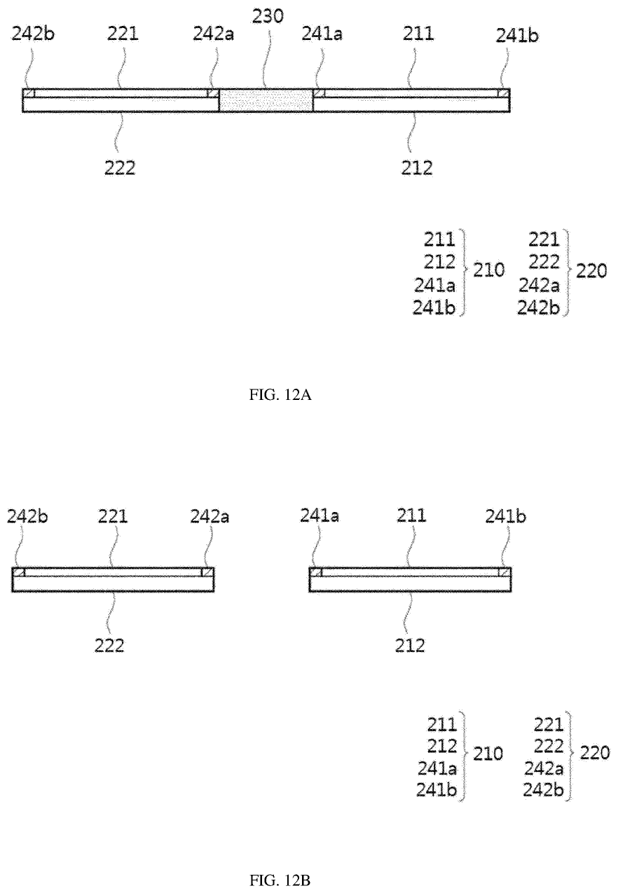

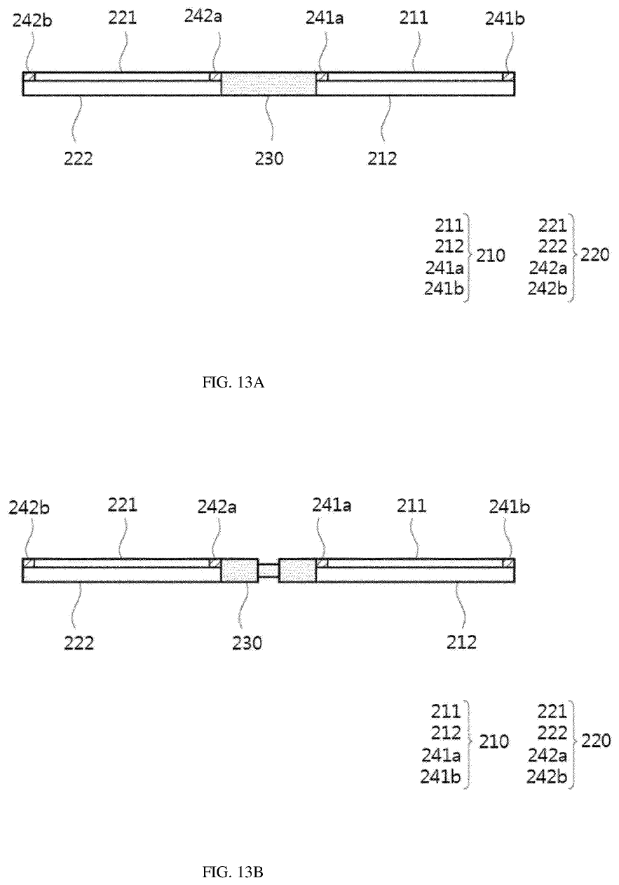

FIGS. 13A and 13B show a variable heating apparatus according to an embodiment of the present disclosure in which the distance between the first transparent heating part and the second transparent heating part can be adjusted by deforming the folding part.

As described in the foregoing embodiment, the folding part may be adjusted between the first transparent heating part and the second transparent heating part.

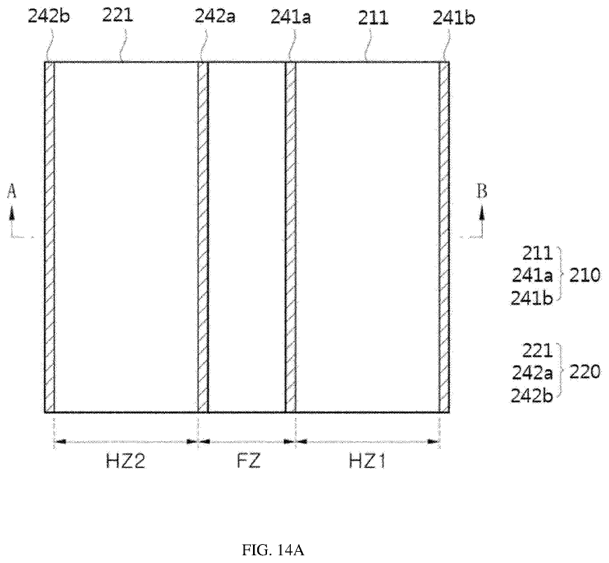

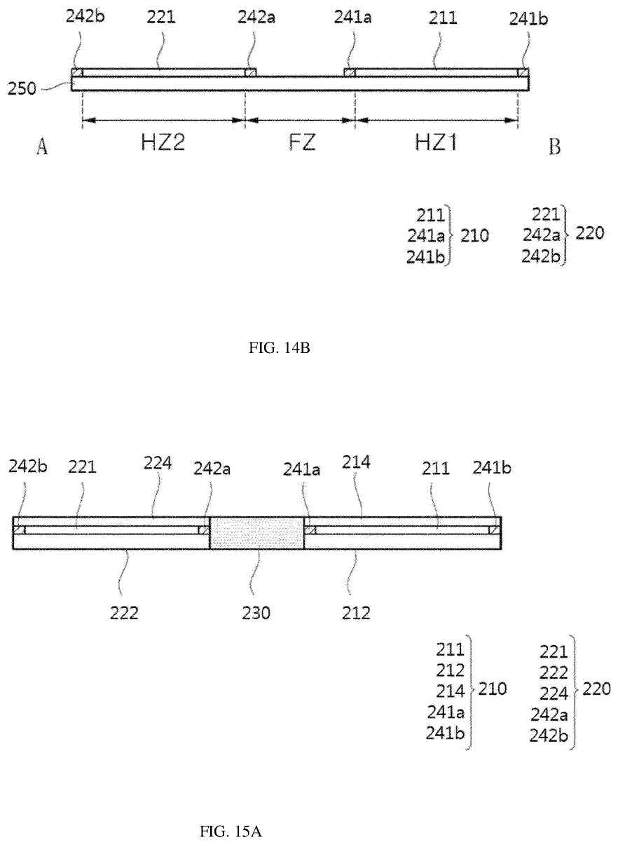

FIG. 14A shows a schematic top view of a variable heating apparatus according to an embodiment of the present disclosure, and FIG. 14B shows a schematic cross-sectional view of the variable heating apparatus taken along line A-B in FIG. 14A.

According to an embodiment of the present disclosure, the variable heating apparatus may include a transparent flexible substrate. Referring to FIGS. 14A and 14B, the variable heating apparatus 200 includes one transparent flexible substrate 250, a first transparent heating part 210, and a second transparent heating part 220, two transparent heating parts of which are provided on one surface of the transparent flexible substrate.

Referring to FIGS. 14A and 14B, the transparent flexible substrate 250 may include a first transparent heating zone HZ1 in which the first transparent heating part 210 is provided; a second transparent heating zone HZ2 in which the second transparent heating part 220 is provided; and a folding zone FZ located between the first transparent heating part 210 and the second transparent heating part 220, wherein the folding part may be a portion of the transparent flexible substrate 250 corresponding to the folding zone FZ. Electrodes 241a and 242a may be provided on the folding zone FZ of the transparent flexible substrate 250.

According to an embodiment of the present disclosure, a separate structure for folding the variable heating apparatus may be omitted by using a flexible transparent substrate as a substrate on which the first and second transparent heating parts are provided. That is, a portion of the transparent flexible substrate on which the first and second transparent heating parts are not provided may be utilized as the folding part.

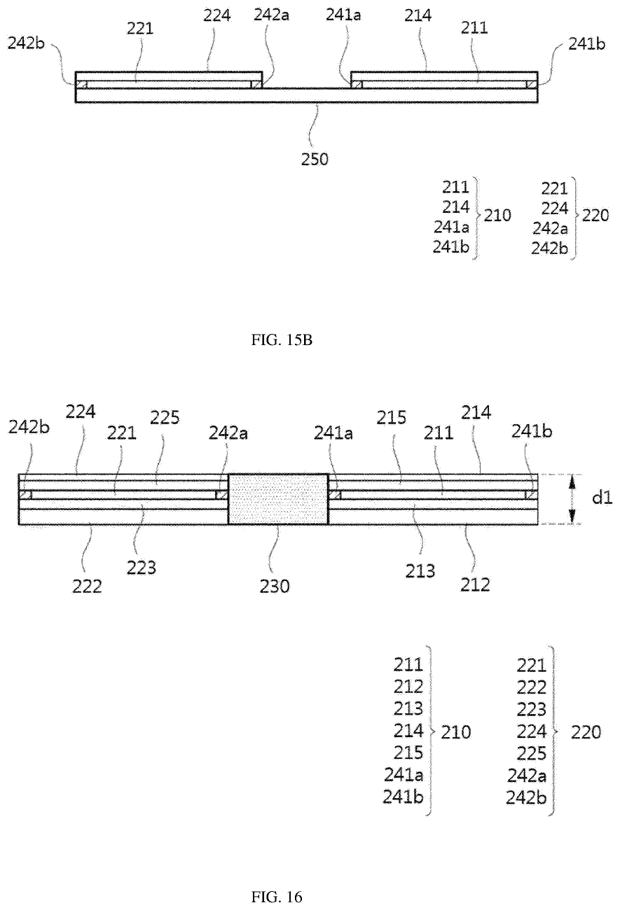

FIGS. 15A and 15B show schematic cross-sectional views of variable heating apparatuses provided with transparent protective layers according to an embodiment of the present disclosure.

According to an embodiment of the present disclosure, the first transparent heating part may further include a first transparent protective layer provided on the first transparent heat generating body, and the second transparent heating part may further include a second transparent protective layer provided on the second transparent heat generating body.

Referring to FIG. 15A, the first transparent heat generating body 211 may be provided on the first transparent substrate 212; the second transparent heat generating body 221 may be provided on the second transparent substrate 222; the first transparent protective layer 214 may be provided to cover the first transparent substrate 212 and the electrodes 241a and 241b; and the second transparent protection layer 224 may be provided to cover the second transparent substrate 222 and the electrodes 242a and 242b.

Referring to FIG. 15B, the first transparent heat generating body 211 and the second transparent heat generating body 221 may be provided on the transparent flexible substrate 250, the first transparent protective layer 214 may be provided to cover the first transparent heat generating body 211 and the electrodes 241a and 241b, and the second transparent protective layer 224 may be provided to cover the second transparent heat generating body 221 and the electrodes 242a and 242b.

The first and second transparent protective layers may protect the first and second transparent heat generating bodies and electrodes by preventing the first and second transparent heat generating bodies and electrodes from directly contacting an object to be heated. Further, the heat generated from the surfaces of the first and second transparent heat generating bodies can be uniformly emitted to the surroundings through the first and second transparent protective layers without being immediately emitted. Glass or a transparent polymer film may be used as the first and second transparent protective layers. For example, the glass used as the first and second transparent protective layers may be mechanically and/or chemically strengthened glass. Additionally, the first and second transparent protective layers may include at least one of a PET film, a PMMA film, a PVDF film, and a PANI film, but the type of the polymer film is not limited to them.

Meanwhile, although not shown in FIG. 15A, the first transparent heating part may include a third transparent protective layer provided under the first transparent substrate, and the second transparent heating part may include a fourth transparent protective layer under the second transparent substrate. In addition, although not shown in FIG. 15B, a fifth transparent protective layer may be provided on the bottom portion of the transparent flexible substrate. The third to fifth transparent protective layers are provided under the first and second transparent substrates and the transparent flexible substrate to prevent heat generated from the first and second transparent heat generating bodies from being discharged to the outside, so that the heating efficiency of the variable heating apparatus can be improved, and it is possible to prevent the user from being injured by heat. Glass or a transparent polymer film may be used as the third to fifth transparent protective layers. For example, the glass used as the third to fifth transparent protective layers may be mechanically and/or chemically strengthened glass. For example, the polymer film may include at least one of a PET film, a PMMA film, a PVDF film, and a PANI film, but the type of the polymer film is not limited to them.

FIG. 16 shows a cross-sectional view of a variable heating apparatus according to an embodiment of the present disclosure.

Referring to FIG. 16, the first transparent heating part 210 may include a structure in which the first transparent substrate 212, the first transparent auxiliary layer 213, the first transparent heat generating body 211, a third transparent auxiliary layer 215, and the first transparent protective layer 214 are sequentially stacked. In addition, the second transparent heating part 220 may include a structure in which the second transparent substrate 222, the second transparent auxiliary layer 223, the second transparent heat generating body 221, a fourth transparent auxiliary layer 225, and the second transparent protective layer 224 are sequentially stacked. The third and fourth transparent auxiliary layers may have the same configuration as the first and second transparent auxiliary layers described above.

For example, in the first transparent heating part 210, a glass as the first transparent substrate 212, a polyimide film as the first transparent auxiliary layer 213, a graphene as the first transparent heat generating body 211, a polyimide film as the third transparent auxiliary layer 215, and a glass as the first transparent protective layer 214 may be used. However, the types of the first transparent substrate 212, the first transparent auxiliary layer 213, the first transparent heat generating body 211, the third transparent auxiliary layer 215 and the first transparent protective layer 214 are not limited to them.

Referring to FIG. 16, the thickness d1 of each of the first transparent heating part 210 and the second transparent heating part 220 may be 4 mm or more and 10 mm or less. When the thicknesses of the first and second transparent heating parts are within the aforementioned range, the durability of the variable heating apparatus can be ensured with the decreasing thickness.

[List of reference signs]

100: Variable heating apparatus
110: First transparent heating part 120: Second
transparent heating part
111: First transparent heat generating body 121:
Second transparent heat generating body
112: First transparent substrate 113: Second
transparent substrate
122: Third transparent substrate 123: Fourth
transparent substrate
130: Folding part
141a, 141b, 142a, 142b: Electrode
141c: First auxiliary electrode 141d: Second
auxiliary electrode
150: Transparent flexible substrate
161: First temperature control part 162:
Second temperature control part
171: First display part 172: Second display part
173a, 173b: Image display part
181: First driving time control part 182: Second
driving time control part
191: First spacer 192: Second spacer
200: Variable heating apparatus
210: First transparent heating part 220:
Second transparent heating part
211: First transparent heat generating body
221: Second transparent heat generating body
212: First transparent substrate 222: Second
transparent substrate
213: First transparent auxiliary layer 223:
Second transparent auxiliary layer
214: First transparent protective layer
224: Second transparent protective layer
215: Third transparent auxiliary layer 225:
Fourth transparent auxiliary layer
230: Folding part

1. A variable heating apparatus comprising:
a first transparent heating part including a first transparent heat generating body;
a second transparent heating part including a second transparent heat generating body; and
a folding part provided between the first transparent heating part and the second transparent heating part.

2. The variable heating apparatus of claim 1, wherein the first transparent heat generating body and the second transparent heat generating body are graphene thin films.

3. The variable heating apparatus of claim 2, wherein the graphene thin film includes a single graphene layer or a plurality of graphene layers.

4. The variable heating apparatus of claim 2, wherein the graphene thin film is doped with a dopant.

5. The variable heating apparatus of claim 1, wherein the first transparent heating part includes a first transparent substrate provided with the first transparent heat generating body, and a second transparent substrate facing the first transparent substrate with the first transparent heat generating body interposed therebetween,
wherein the second transparent heating part includes a third transparent substrate provided with the second transparent heat generating body, and a fourth transparent substrate facing the third transparent substrate with the second transparent heat generating body interposed therebetween,
wherein the first transparent substrate and the second transparent substrate are sealed such that an air gap is formed between the first transparent substrate and the second transparent substrate, and
wherein the third transparent substrate and the fourth transparent substrate are sealed such that an air gap is formed between the third transparent substrate and the fourth transparent substrate.

6. The variable heating apparatus of claim 5, wherein the first transparent heating part includes a first spacer which is provided between the first transparent substrate and the second transparent substrate to seal the first transparent substrate and the second transparent substrate, and
wherein the second transparent heating part includes a second spacer which is provided between the third transparent substrate and the fourth transparent substrate to seal the third transparent substrate and the fourth transparent substrate.

7. The variable heating apparatus of claim 5, wherein the air gap contains an inert gas.

8. The variable heating apparatus of claim 5, wherein the first transparent heating part further includes an electrode connected to the first transparent generating body, and
wherein the second transparent heating part further includes an electrode connected to the second transparent heat generating body.

9. The variable heating apparatus of claim 1, wherein the folding part is attachable to and detachable from the first transparent heating part and the second transparent heating part.

10. The variable heating apparatus of claim 1, further comprising a transparent flexible substrate,
wherein the transparent flexible substrate includes a first transparent heating zone provided with the first transparent heating part; a second transparent heating zone provided with the second transparent heating part; and a folding zone located between the first transparent heating part and the second transparent heating part, and
wherein the folding part is a portion of the transparent flexible substrate corresponding to the folding zone.

11. The variable heating apparatus of claim 1, further comprising:
a first temperature control part connected to the first transparent heat generating body to control the degree of heat generation of the first transparent heat generating body; and
a second temperature control part connected to the second transparent heat generating body to control the degree of heat generation of the second transparent heat generating body.

12. The variable heating apparatus of claim 1, further comprising:
a first driving time control part connected to the first transparent heat generating body to control the driving time of the first transparent heat generating body; and
a second driving time control part connected to the second transparent heat generating body to control the driving time of the second transparent heat generating body.

13. The variable heating apparatus of claim 1, further comprising:
a first display part connected to the first transparent heat generating body to display driving information including temperature and driving time of the first transparent heat generating body; and
a second display part connected to the second transparent heat generating body to display driving information including temperature and driving time of the second transparent heat generating body.

14. The variable heating apparatus of claim 13, wherein each of the first display part and the second display part includes a light emitting device that changes its color according to the temperature of a transparent heat generating body.

15. The variable heating apparatus of claim 1, wherein at least one of the first transparent heating part and the second transparent heating part further includes an image display part for outputting an image.

16. The variable heating apparatus of claim 1, wherein the first transparent heating part further includes a first transparent substrate provided with the first transparent heat generating body, and an electrode connected to the first transparent heat generating body, and
wherein the second transparent heating part further includes a second transparent substrate provided with the second transparent heat generating body, and an electrode connected to the second transparent heat generating body.

17. The variable heating apparatus of claim 16, wherein the first transparent heating part further includes a first transparent auxiliary layer provided between the first transparent heat generating body and the first transparent substrate, and
wherein the second transparent heating part further includes a second transparent auxiliary layer provided between the second transparent heat generating body and the second transparent substrate.

18. The variable heating apparatus of claim 1, wherein the first transparent heating part further includes a first transparent protective layer provided on the first transparent heat generating body, and
wherein the second transparent heating part further includes a second transparent protective layer provided on the second transparent heat generating body.
